(19) United States
(12) Patent Application Publication
(10) Pub. No.: US 2026/0103547 A1
(43) Pub. Date: Apr. 16, 2026

(54) METHOD OF PRODUCING OLIGOSACCHARIDE AMPHIPHILES

(71) Applicants: WILMAR INTERNATIONAL LIMITED, Singapore (SG); NATIONAL UNIVERSITY OF SINGAPORE, Singapore (SG)

(72) Inventors: Junyu MI, Singapore (SG); Ning YAN, Singapore (SG); Shijie YU, Singapore (SG); Kian Hong NG, Singapore (SG); Shoucang SHEN, Singapore (SG)

(73) Assignees: WILMAR INTERNATIONAL LIMITED, Singapore (SG); NATIONAL UNIVERSITY OF SINGAPORE, Singapore (SG)

(21) Appl. No.: 19/357,663

(22) Filed: Oct. 14, 2025

(30) Foreign Application Priority Data
Oct. 15, 2024 (SG) 10202403214U

(51) Int. Cl. C08B 37/00; B01J 27/02; B01J 27/10; B01J 27/16; B01J 31/02; C08B 1/00; C11D 3/22

(52) U.S. Cl. CPC C08B 37/0057; B01J 27/02; B01J 27/10; B01J 27/16; B01J 31/0225; C08B 1/003; C11D 3/222

(57) ABSTRACT

Disclosed herein is a method of obtaining an oligosaccharide amphiphile. Also disclosed herein is an oligosaccharide amphiphile obtained by the method, as well as micelles, surfactants, and compositions comprising said oligosaccharide amphiphile obtained by the method disclosed herein.

### CROSS-REFERENCE TO RELATED APPLICATIONS

This application claims the benefit of priority of Singapore provisional application no. 10202403214U, filed 15 Oct. 2024, the contents of it being hereby incorporated by reference in its entirety for all purposes.

### TECHNICAL FIELD

The present invention relates generally to the field of organic chemistry. In particular, the present invention relates to a method of obtaining an oligosaccharide amphiphile, micelles, surfactants, and compositions comprising oligosaccharide amphiphiles thereof.

### BACKGROUND

Surfactants are amphiphilic molecules, containing both hydrophilic and hydrophobic components, enabling them to mix immiscible phases such as oil and water, air and water, and solid and liquid by reducing interfacial tension. Conventionally, surfactants are obtained from petroleum-based chemicals and face issues of low biodegradability, and are more likely to cause irritation to skin and eyes.

Surfactants derived from biomass are an alternative to synthetic surfactants. However, conventional processes of deriving surfactants from biomass, such as two-step valorization processes, require large amounts of resources including water and solvents, and are complex and costly.

There is thus an unmet need for an improved method of obtaining surfactants from biomass which solves at least some of the above problems.

### SUMMARY

In one aspect, provided herein is a method of obtaining an oligosaccharide amphiphile, the method comprising the steps of: i. providing a mixture comprising: a plant-derived biomass; a fatty alcohol; and an acid catalyst; ii. subjecting the mixture of step i to rotary evaporation, thereby obtaining a phase; iii. subjecting the phase of step ii to ball milling at a temperature of at least 90° C.; and iv. mixing the phase of step iii with water and purifying the resulting mixture to obtain an oligosaccharide amphiphile.

In another aspect, provided herein is an oligosaccharide amphiphile obtained by the method as disclosed herein.

In another aspect, provided herein is a micelle comprising an oligosaccharide amphiphile as disclosed herein.

In another aspect, provided herein is a surfactant comprising an oligosaccharide amphiphile method as disclosed herein.

In another aspect, provided herein is a composition comprising a micelle or a surfactant method as disclosed herein.

In another aspect, provided herein is a use of a micelle or a surfactant as disclosed herein in the manufacture of a personal care and/or a home care product.

In another aspect, provided herein is a micelle or a surfactant as disclosed herein for use in personal care and/or in home care products.

In another aspect, provided herein is home care product comprising a micelle or a surfactant as disclosed herein.

In another aspect, provided herein is a personal care product comprising a micelle or a surfactant as disclosed herein.

### BRIEF DESCRIPTION OF FIGURES

FIG. 1 is a schematic diagram showing examples of conventional surfactants and a general surfactant obtained from the method as described herein. FIG. 1A is a schematic diagram showing examples of conventional synthetic surfactants and their properties. FIG. 1B is a schematic diagram showing an example of a conventional surfactant derived from a biomass and a conventional method of obtaining said surfactant from biomass. FIG. 1C is a schematic diagram showing a general scheme of the method as described herein and properties of said method. FIG. 1D is a schematic diagram showing a general scheme of the method as described herein and an example of a conventional method of obtaining surfactants from biomass.

FIG. 2 shows the characterization of Cellulose-C8 oligosaccharide amphiphile as described herein. FIG. 2A is an ESI-MS graph showing the ESI-MS spectra of octyl glucosides having a degree of polymerization (DP) between n=1 to n=8. M/z peaks of up to 1500 are observed. FIG. 2B is a GPC chromatogram graph showing the GPC chromatogram of the molecular weight distribution of Cellulose-C8 oligosaccharide amphiphile as described herein. FIG. 2C is an NMR spectra graph of the ¹H NMR spectra showing the molecular structure of the Cellulose-C8 oligosaccharide amphiphile (CellC8) as described herein with markers for sugar anomeric H₁, pyranose ring H₁ to H_{6′}, and alkyl chain H protons. Set conditions of the method for obtaining Cellulose-C8 oligosaccharide amphiphile as described in FIG. 2: ball milling speed in step iii was set at 500 rpm, temperature of ball milling in step iii was set at 110° C., duration of the ball milling in step iii was set at 30 minutes, 25 mol % octanol and 1 wt % of acid catalyst relative to microcrystalline cellulose (MCC) was used in step i.

FIG. 3 shows the effects of ball milling speed and temperature on the transetherification of cellulose. FIG. 3A is a line graph showing the effect of ball milling speed on the conversion of cellulose and fatty alcohol to oligosaccharide amphiphile, and the ratio of sugar to alkyl in the resulting oligosaccharide amphiphile. FIG. 3B is a bar graph showing the effect of ball milling speed on the abundance of anomeric linkages of the saccharide component in the depolymerized oligosaccharide amphiphile. FIG. 3C is a line graph showing the effect of temperature on the conversion of cellulose and fatty alcohol to oligosaccharide amphiphile. FIG. 3D is a bar graph showing the effect of temperature on the abundance of anomeric linkages of the saccharide component in the depolymerized oligosaccharide amphiphile. FIG. 3E is a schematic diagram showing the branch points in an oligosaccharide. Set conditions of the method for transetherification of cellulose as described in FIG. 3: Duration of the ball milling in step iii was set at 30 minutes, 25 mol % of octanol and 1 wt % of acid catalyst relative to microcrystalline cellulose (MCC) was used in step i. Temperature of ball milling in step iii was set at 110° C. in FIGS. 3A and 3B. Ball milling speed in step iii was set at 700 rpm in FIGS. 3C and 3D.

FIG. 4 shows the analysis of microcrystalline cellulose upon treatment under different conditions. FIG. 4A is an X-ray Crystallography (XRD) spectra graph showing the X-ray Crystallography (XRD) spectra analysis of microcrystalline cellulose upon treatment under different conditions (MCC: no treatment; H: heating only; BM: ball milling only; BM+H: ball milling and heating). FIG. 4B is a line graph showing the torque exerted on the stirring paddle by the contents during ball milling with and without heating (BM: ball milling only; BM+H: ball milling and heating). FIG. 4C is a line graph showing the outer angular velocity of moving balls during ball milling, with and without heating (BM: ball milling only; BM+H: ball milling and heating). FIG. 4D is a schematic diagram showing the velocity gradient differences in viscous balls compared to less viscous balls during ball milling. FIG. 4E is a differential scanning calorimetry (DSC) spectra graph showing the glass transition temperature (T_{g}) of cellulose as measured by differential scanning calorimetry (DSC) spectra upon treatment under different conditions (MCC: no treatment; BM: ball milling only; BM+H: ball milling and heating). Acid was removed prior to measurement of the glass transition temperature (T_{g}) of cellulose by differential scanning calorimetry (DSC) spectra. Set conditions for FIG. 4: 25 mol % octanol and 1 wt % of acid catalyst relative to microcrystalline cellulose (MCC) was used in step i, ball milling speed in step iii was set at 700 rpm and temperature of ball milling in step iii was set at 110° C.

FIG. 5 shows an analysis of the surface tension and micelle formation of oligosaccharides amphiphiles as described herein. FIG. 5A is a dot graph showing the changes in surface tension relative to concentration for cellooligosaccharides amphiphiles derived from C8 or C12 alcohol (CellC8: oligosaccharide amphiphile derived from C8 alcohol and cellulose; CellC12: oligosaccharide amphiphile derived from C12 alcohol and cellulose; S:A denotes the average sugar moiety to alkyl moiety mole ratio in the oligosaccharide amphiphiles). FIG. 5B is a dot graph showing the changes in surface tension relative to concentration for C12-oligosaccharides amphiphiles derived from different types of biomass (WBC12: wheat bran, SDC12: sawdust, and PKMC12: palm kernel meal, where S:A denotes the average sugar moiety to alkyl moiety mole ratio in the oligosaccharide amphiphiles). FIG. 5C is a bar graph showing the critical micelle concentration (CMC) for the oligosaccharides amphiphiles as described in FIGS. 5A and 5B and commercially available surfactants. FIG. 5D is a schematic diagram showing the effect of sugar-to-alkyl ratio on critical micelle concentration (CMC) and critical packing parameter (Cₚₚ). CellC12 S:A 26.9* as referred to in FIG. 5 is a blend mixture of CellC12 S:A 12.8 with pure cellooligosaccharides, such that the final S:A ratio was close to CellC12 S:A 26.9 sample.

FIG. 6 shows a comparison between an example of an oligosaccharide amphiphile as described herein and conventional surfactants. FIG. 6A is a bar graph showing the contact angle for an oil droplet in 10 mg/ml of CellC12 or conventional surfactants. FIG. 6B is a line graph showing the contact angle for CellC12 and MES at various concentrations. FIG. 6C is a schematic diagram showing the oil de-wetting mechanisms for varying hydrophilic group sizes. FIG. 6D is a bar graph showing the Zein value of CellC12 and conventional surfactants. FIG. 6E is a bar graph showing the water solubility of CellC12 and conventional surfactants.

FIG. 7 is a COSY spectra graph showing the structural analysis of proton interactions within alkyl chains, pyranose rings, and anomeric protons of cellulose-C8 oligosaccharide amphiphile as demonstrated by COSY spectra.

FIG. 8A is a NMR spectra graph showing the structural analysis of cellulose-C8 oligosaccharide amphiphile as demonstrated by ¹³C NMR spectra analysis. FIG. 8B is a HSQC spectra graph showing the structural analysis of cellulose-C8 oligosaccharide amphiphile as demonstrated by HSQC spectra.

FIG. 9 is a NMR spectra graph showing the ¹H NMR spectra comparative analysis of cellulose-C8 oligosaccharide amphiphile, octyl glucosides, cellooligosaccharides depolymerized from cellulose, cellotriose, cellobiose, and glucose.

FIG. 10 is a schematic diagram showing the reaction pathways for transetherification and hydrolysis during cellulose depolymerization.

FIG. 11 shows the effect of different conditions on the conversion of long-chain alcohol and cellulose to oligosaccharide amphiphiles, and the sugar-to-alkyl ratio in the resulting oligosaccharide amphiphile. FIG. 11A are line graphs showing the effect of carbon number in alcohol for the conversion of long-chain alcohol and cellulose to oligosaccharide amphiphiles, and the sugar-to-alkyl ratio in the resulting oligosaccharide amphiphile. FIG. 11B are line graphs showing the effect of acid concentration in the conversion of long-chain alcohol and cellulose to oligosaccharide amphiphiles, and the sugar-to-alkyl ratio in the resulting oligosaccharide amphiphile. FIG. 11C are line graphs showing the effect of alcohol content in the conversion of long-chain alcohol and cellulose to oligosaccharide amphiphiles, and the sugar-to-alkyl ratio in the resulting oligosaccharide amphiphile. FIG. 11D is a table showing the conversion of microcrystalline cellulose (MCC) with fatty alcohols of increasing carbon number, in different reaction conditions. Set conditions for FIG. 11D: ball milling speed in step iii was set at 700 rpm, temperature of ball milling in step iii was set at 110° C., duration of the ball milling in step iii was set at 30 minutes.

FIG. 12 shows the characterization of C12-oligosaccharide amphiphile derived from different types of biomasses. FIG. 12A is a NMR spectra graph showing the S:A values of C12-oligosaccharide amphiphiles derived from different types of biomasses as demonstrated by ¹H NMR spectra (CellC12: C12-oligosaccharide amphiphile derived from cellulose; WBC12: C12-oligosaccharide amphiphile derived from wheat bran; PKMC12: C12-oligosaccharide amphiphile derived from palm kernel meal; SDC: C12-oligosaccharide amphiphile derived from sawdust). FIG. 12B shows pie charts showing the sugar composition in oligosaccharide amphiphile derived from biomass and the sugar utilization efficiency, referred to as total yield (WBC12: C12-oligosaccharide amphiphile derived from wheat bran; PKMC12: C12-oligosaccharide amphiphile derived from palm kernel meal; SDC12: C12-oligosaccharide amphiphile derived from sawdust).

FIG. 13 shows the characterization of conventional surfactants. FIG. 13A is a dot graph showing the changes in surface tension relative to concentration of conventional surfactants. FIG. 13B is a schematic diagram showing the general structures of conventional surfactants. FIG. 13C is a table showing the critical micelle concentration (CMC) and γCMC of conventional surfactants.

FIG. 14A are snapshots showing the rotation track of the black reference ball in ball milling+heating (BM+H) conditions. FIG. 14B is a schematic showing the rotation track of the black reference ball in ball milling (BM) conditions. The rotation occurs in a clockwise direction with a time interval of 1/240 s between frames.

FIG. 15 shows an analysis of the surface tension and micelle formation of oligosaccharides amphiphiles as described herein. FIG. 15A is a schematic diagram showing the production mass balance of C12 alcohol-functionalized oligosaccharides from wheat bran and poplar sawdust. *The monosaccharide units of the C12-functionalized oligosaccharide amphiphiles are composed of glucose, xylose, and arabinose. **The monosaccharide units of the C12—functionalized oligosaccharide amphiphiles are composed of glucose and xylose. FIG. 15B is a dot graph showing the surface tension reduction profile for C12-functionalized oligosaccharide amphiphiles derived from biomass (WB: wheat bran, SD: poplar sawdust). FIG. 15C is a dot graph showing the surface tension across different concentrations of cellooligosaccharides functionalized with C8-C14 alcohol. FIG. 15D is a bar graph showing the critical micelle concentration (CMC) for the oligosaccharide amphiphiles described herein relative to conventional surfactants. FIG. 15E is a schematic diagram showing the material mass balance for C12-functionalised wheat bran. FIG. 15F is a schematic diagram showing the material mass balance for C12-functionalised poplar sawdust.

FIG. 16 is a table showing the comparative analysis of processability for cellulose compared to biomass. a Reaction conditions: reaction temperature of 110° C., ball-milling speed of 700 rpm, dodecanol (C12) as the fatty alcohol used in the method. b The mol % is relative to biomass substrate. c The yield (mol %) is calculated as the moles of monosaccharide units extracted in the oligosaccharides amphiphile relative to the moles of monosaccharide units in the biomass substrate. d S:A is the molar ratio between the monosaccharide units to alkyl groups in the alkyl-functionalized oligosaccharides amphiphile. e 67.8 mol % is the molar yield of monosaccharide units (both pentose and hexose) extracted from biomass.

FIG. 17 shows the qNMR analysis of the DPₙ, and oligosaccharide and alkyls from oligosaccharide amphiphiles obtained by the method described herein.

### DEFINITIONS

As used herein, the term “transetherification” refers to a chemical process in which one ether group (R₁—O—R₂) in a compound is exchanged with another ether group. The reaction typically occurs between an ether and an alcohol in the presence of, for example, a protonic acid catalyst, whereby the catalyst activates the ether's oxygen atom. The acid protonates the oxygen atom of the ether, increasing the oxygen atom's electrophilicity and facilitating a nucleophilic attack by the alcohol (the nucleophile, R₃—OH). As a result, one alkyl group (R₂) is displaced, leading to the formation of a new ether (R₁—O—R₃), whereby R₃ originates from the alcohol. A general example of a transetherification process is shown below:

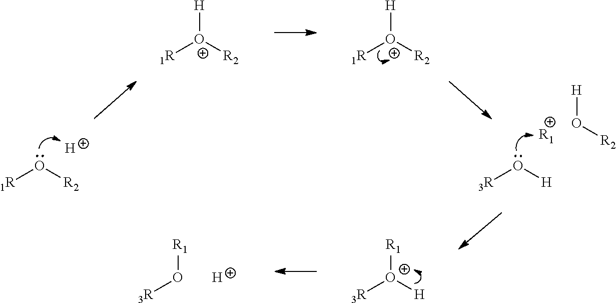

As used herein, the term “oligosaccharide amphiphile” refers to a molecule comprising an oligosaccharide chain, wherein the oligosaccharide chain comprises hydrophobic and hydrophilic groups. The oligosaccharide amphiphile as obtained by the method described in the present disclosure can have a degree of polymerisation of at least 3, and up to 8. The oligosaccharide amphiphile as obtained by the method described in the present disclosure thus has a higher degree of polymerisation compared to other alkyl polyglycosides and surfactants derived from biomass using conventional methods, where the degree of polymerization is typically up to 2. The oligosaccharide amphiphile as obtained by the method described in the present disclosure can also have a branched structure, which increases solubility relative to surfactants derived from biomass using conventional methods.

As used herein, the term “acid catalyst” refers to an acid which can increase the rate of a chemical reaction occurring between two reactants, such as a transetherification reaction. As described herein, the acid catalyst catalyses a transetherification reaction between an ether and an alcohol. In one example, the acid catalyst catalyses a transetherification reaction between a plant-derived biomass and a fatty alcohol. In another example, the acid catalyst is a protonic acid catalyst.

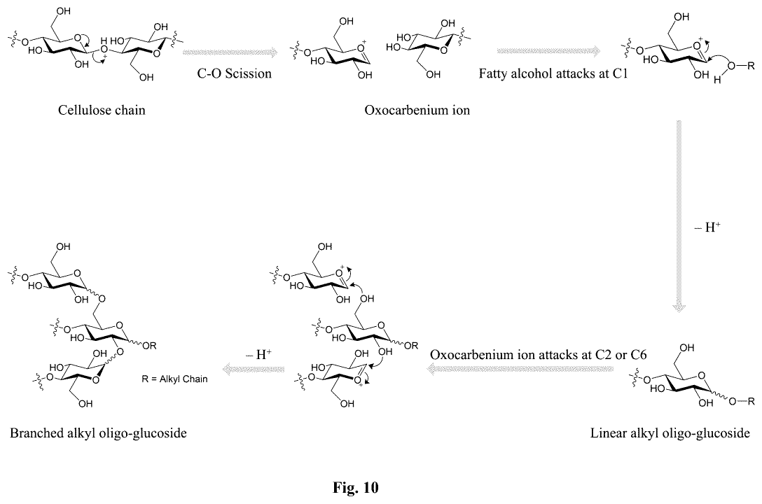

As used herein, the term “protonic acid” refers to an acid that can disassociate and release hydrogen ions in a solution. The released hydrogen ions can protonate the glycosidic bonds in the plant-derived biomass of the method as disclosed herein to enable cleavage of the glycosidic bonds for initiating the subsequent chemical reactions. A general example of the protonation of glycosidic bonds in the biomass by the method as disclosed herein is shown in FIG. 10. In one example, the protonic acid can be, but is not limited to, sulfuric acid, hydrochloric acid, phosphoric acid, or p-toluene sulfonic acid. In another example, the protonic acid is sulfuric acid.

As used herein, the term “plant-derived biomass” refers to organic material derived from a plant. The plant-derived biomass can be, but is not limited to, microcrystalline cellulose, sawdust, palm kernel meal, wheat bran, or any other whole or part thereof of a plant. In one example, the plant-derived biomass comprises a carbohydrate. In another example, the carbohydrate is a structural carbohydrate. In yet another example, the carbohydrate is a non-structural carbohydrate.

As used herein, the term “structural carbohydrate” refers to a carbohydrate which aids in structural integrity of a biomass and can be, but is not limited to, cellulose, hemicellulose, or lignin. Thus, in one example, the structural carbohydrate can be, but is not limited to, cellulose or hemicellulose.

As used herein, the term “non-structural carbohydrate” refers to a carbohydrate that does not contribute to the structural integrity of a biomass. Thus, the carbohydrate can be a storage carbohydrate. In one example, the non-structural carbohydrate can be, but is not limited to, starch, glucose, fructose, galactose, sucrose, lactose, maltose, hexose, dextrose, mannose, pentose, xylose, or cellobiose. In one example, the storage carbohydrate is starch. In another example, the carbohydrate is sucrose. In yet another example, the carbohydrate is a product of an enzymatic digestion of starch or sucrose. Accordingly, examples of biomass which contain a non-structural carbohydrate can be, but is not limited to, wheat bran, sawdust, or palm kernel meal.

As used herein, the term “fatty alcohol” refers to a straight-chain primary alcohol, which can comprise from 4 to 30 carbon atoms and can be, but is not limited to, 1-hexanol, 1-octanol, 1-nonanol, 1-decanol, or 1-dodecanol. In one example, the fatty alcohol comprises at least 6 carbon atoms. In another example, the the fatty alcohol comprises between 6 to 18 carbons. In another example, the fatty alcohol comprises between 6 to 12 carbons. In one example, the fatty alcohol comprises 6, 7, 8, 9, 10, 11, 12, 13, 14, 15, 16, 17, or 18 carbon atoms.

As used herein, the term “DPₙ” refers to the average degree of polymerization of saccharides per alkyl group. The term “DPₙ” is used interchangeably with the term “sugar-to-alkyl ratio”.

As used herein, the term “rotary evaporation” is known in the art and refers to the removal of a liquid from a solution upon the application of heat, where the solution is contained within a rotating vessel. Thus, in one example, step ii of the method removes the mixing agent from the mixture in step i by rotary evaporation. In another example, subjecting the mixture of step i to rotary evaporation results in a phase. In another example, steps (i) to (iv) are carried out in a vessel.

As used herein, the term “solvent-free” refers to the absence of a solvent in step i of the method as described herein, such that the alcoholysis reaction occurring in step iii of the method also does not have a solvent. Generally, a solvent-free reaction can mean that other substances which do not participate in the reaction can be used for the purposes of, for example, mixing the reactants, washing out unreacted reactants, or homogenising the reactants for a subsequent chemical reaction. Such substances do not participate in the reaction due to, for example, an absence during the alcoholysis reaction, or a general unreactivity to the reactants. Thus, in one example, a “solvent-free” reaction can include the use of a mixing agent.

As used herein, the term “mixing agent” refers to a substance which can be used to homogeneously mix reactants before a reaction. In one example, step i of the method described herein comprises a mixing agent. In another example, a mixing agent is used to mix the reactants of step i, where the reactants comprise a fatty alcohol, an acid catalyst, and a plant-derived biomass. As described herein, the mixing agent dissolves the fatty alcohol and provides a solution for the acid catalyst to protonate. In another example, the mixing agent is evaporated in step ii, prior to the alcoholysis reaction in step iii. In yet another example, a mixing agent can be used to wash out unreacted alcohols after a reaction. In a further example, a mixing agent is used in step iv to wash out unreacted alcohols after the alcoholysis reaction in step iii.

As used herein, the term “critical micelle concentration”, also referred to as “CMC”, refers to the concentration of a substance, such as a surfactant, above which a micelle will form.

As used herein, the term “zein value” refers to a value or number derived from performing a zein test. As used herein, the term “zein test”, also known as a zein solubilization test, refers to a test which measures the amount of zein, a corn protein, that is solubilized in 100 mL of surfactant solution. Generally, zein is water-insoluble and would be rendered soluble by addition of, for example, a surfactant, surfactant-based product, or surfactant solution. The amount of solubilized zein is measured by measuring the amount of nitrogen (provided in milligrams (mg) nitrogen) in the solution. The zein value is used in the art as a measure of the protein denaturation or (skin) irritation potential of a test product. The lower the zein value or zein number, the lower the irritation potential of the product being tested. In other words, skin irritation has been shown to increase with increasing solubility of zein. For reference, in the context of the present disclosure, a zein value of below 100 is considered to indicate poor protein solubility and therefore low skin irritation potential of a tested substance. In contrast, a zein value of 400 is considered to indicate strong irritation potential of the tested substance.

As used herein, the term “molar percentage (mol %)” or “mol %” refers to the number of moles of a solute dissolved in a litre of solution.

As used herein, the term “weight percentage (wt %)” or “wt %” in the context of alcohol refers to the amount of alcohol relative to the biomass weight. Generally, the term “wt %” can be calculated using known methods in the art to derive the corresponding molar percentage (mol %). For example, as used herein, a 20 wt % of an 8 carbon atom (C8) alcohol can be calculated to be equivalent to be about 25 mol %. In another example, when a 12 carbon atom (C12) alcohol is used in the method disclosed herein, the required amount of C12 alcohol can be between 20 wt % to 100 wt %. The corresponding amount in mol % can be calculated based on known methods in the art.

As used herein, the term “about”, in the context of, for example, temperatures at which the method is performed, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

### DETAILED DESCRIPTION

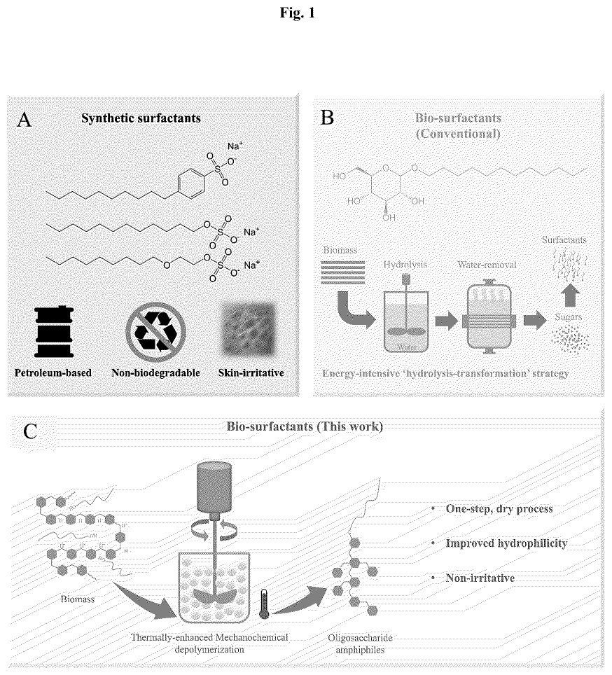

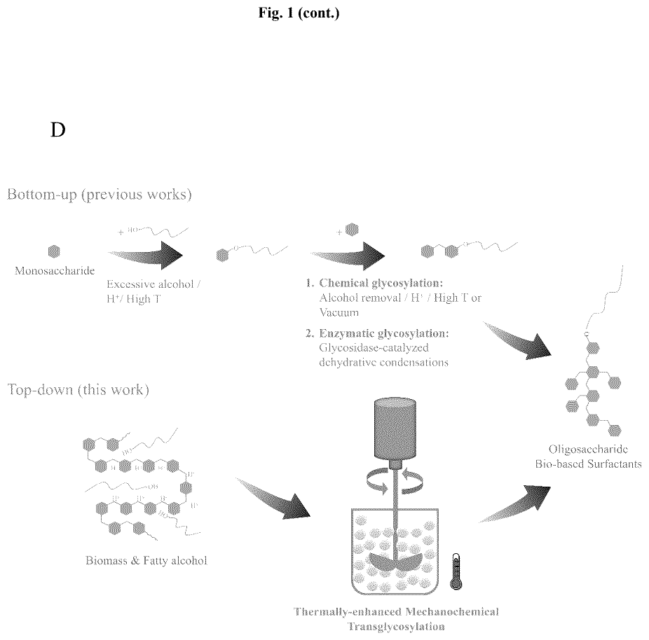

Surfactants are amphiphilic molecules, containing both hydrophilic and hydrophobic components, enabling them to mix immiscible phases such as oil and water, air and water, and solid and liquid by reducing interfacial tension. This property has led to their use in cosmetics, personal care, pharmaceuticals, homecare, textiles, and oil refining. Conventionally, surfactants such as sodium lauryl sulfate (SLS), sodium laureth sulfate (SLES), and linear alkylbenzene sulfonates (LABs) are obtained from petroleum-based chemicals such as paraffins, olefins, and aromatic hydrocarbons. Conventional surfactants derived from petroleum-based chemicals face issues of low biodegradability and are more likely to cause irritation to skin and eyes (FIG. 1A).

Surfactants can also be derived from biomass, such as methyl ester sulfonate (MES) which is derived from vegetable oils. However, surfactants derived from biomass are often obtained using conventional two-step valorization processes. Conventional processes of obtaining surfactants from biomass require solvents with high boiling points and reactants, or comprise multiple separation steps such as distillation, extraction, and crystallization to recover solvents and unreacted reactants, leading to high energy demands and product yield losses (FIGS. 1B and 1D). For example, conventional methods of obtaining surfactants from lignocellulosic biomass require large amounts of water for hydrolysis as the initial depolymerization step, followed by subsequent steps to obtain surfactants. Removing water from downstream reactions requires large amounts of heat energy due to its high latent heat of vaporization and miscibility with the products.

Described herein is a method of obtaining surfactants from biomass. In one example, the method disclosed herein is a method of obtaining an oligosaccharide amphiphile from biomass.

Basis for the method described herein is a transetherification reaction as described above. In summary, a transetherification reaction occurs between a fatty alcohol and a carbohydrate in the presence of an acid catalyst to produce an oligosaccharide amphiphile. A general example of the transetherification reaction described herein can be found in FIG. 10.

To increase the rate or extent of transetherification reaction, the variables under which the transetherification reaction takes place can be altered. Examples of such variables can be, but are not limited to, temperature, concentration of reactants, surface area of the reactants, the introduction of mechanical forces, or combinations thereof.

### Effects of Ball-Milling and Heating on Transetherification

As shown herein, ball milling at high-temperature results in depolymerization of cellulose via transetherification. Hence, the effects of ball milling and heating on transetherification were analysed by quantifying the conversion of both the alcohol and cellulose using ¹H NMR spectroscopy. Subsequently, the sugar ring to alkyl chain mole ratio in the resultant product was determined to assess the extent of transetherification. Through quantitative analysis of the anomeric region in the NMR spectra, the mole percentage of the β(1,4) glycosidic backbone (referred to as the β(1,4) stem) and the α/β-(1,2) and α/β-(1,6) branches in the sugar component were determined.

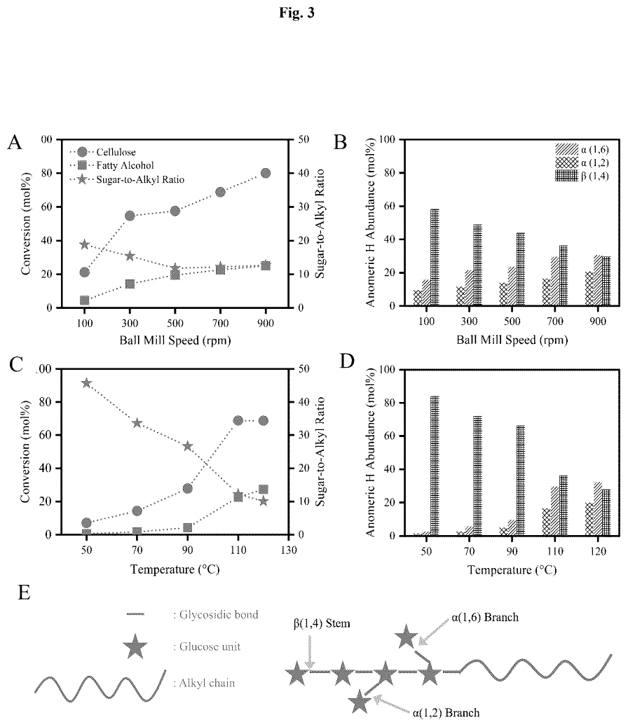

Next, the temperature was fixed at 110° C. and the ball milling speed was increased from 100 to 900 rpm. As shown in FIG. 3A, increasing the ball milling speed up to 900 rpm increased the conversion of reactants. Specifically, the conversion of cellulose increased from 21% to 80%, and the conversion of octanol increased from 5% to 25%. Additionally, the sugar-to-alkyl ratio decreased from 18.8 to 11.8 up to 500 rpm, after which it remained between 12 and 13 until 900 rpm. Furthermore, the structure of the sugar components showed a higher degree of branching with increased ball milling speed, as shown by FIG. 3B.

In one example, the introduction of mechanical forces can be performed using ball milling. In one example, the rate or extent of transetherification reaction occurring between a fatty alcohol and a carbohydrate in the presence of an acid catalyst to produce an oligosaccharide amphiphile, is increased by performing the transetherification reaction with ball milling.

As shown herein, the introduction of ball-milling during a transetherification reaction occurring between a plant-derived biomass and a fatty alcohol increases the extent of transetherification occurring between the plant-derived biomass and fatty alcohol (FIGS. 3A and 3B). Thus, in one example, the method as disclosed herein can include a ball milling step. In a further example, the ball milling is performed during step iii of the method as described herein. In one example, step iii is conducted at a ball milling speed of at least 200 rounds per minute (rpm). In another example, step iii is conducted at a ball milling speed of between 200 rpm to 1000 rpm. In one example, step iii is conducted at a ball milling speed of about 300 rpm, about 400 rpm, about 500 rpm, about 600 rpm, about 700 rpm, about 800 rpm, or about 900 rpm.

### Mechanistic Analysis

As depicted in FIGS. 1A and 1C, transetherification can be increased by heating. Experiments were conducted with ball-milling only (BM) or heating only (H). Ball-milling+heating (BM+H) condition resulted in a microcrystalline cellulose (MCC) conversion of approximately 70%.

Similarly, as shown in FIG. 3C, by fixing the ball milling speed at 700 rpm, it was determined that temperature increases the extent of transetherification. As shown in FIG. 3C, at 50° C., there was negligible depolymerization of microcrystalline cellulose (MCC). Additionally, the product exhibited a sugar-to-alkyl ratio of approximately 50, indicating minimal functionalization with the octyl group. As the temperature increased to 90° C., cellulose depolymerization was increased. Further elevation of the temperature to 110° C. resulted in an increase in the conversion of both cellulose and alcohol. Elevated temperatures can also increase the degree of branching as illustrated in FIG. 3D.

As shown herein that the extent of transetherification occurring between the plant-derived biomass and fatty alcohol can be altered by temperature (FIGS. 3C and 3D). Thus, in one example, the method as disclosed herein is performed under heating. In a further example, the heating is applied during step iii of the method as described herein. In one example, step iii is conducted at a temperature of at least 110° C. In another example, step iii is conducted at a temperature of between 110° C. to 160° C. In one example, step iii is conducted at a temperature of between 110° C. to 120° C. In another example, step iii is conducted at a temperature of about 110° C., 111° C., 112° C., 113° C., 114° C., 115° C., 116° C., 117° C., 118° C., 190° C., or 120° C. In another example, step iii is conducted at a temperature of about 110° C.

As shown in FIG. 10, the cleavage of the C1-04′ bond forms an unstable oxocarbenium ion, which is susceptible to nucleophilic attacks. Generally, due to steric hindrance and electronic effects from the R groups, alkoxides from fatty alcohol are considered to be less effective nucleophiles than hydroxides, making nucleophilic attacks less favourable. Additionally, cellulose transetherification using butanol (C4) requires an activation energy of about 148 kJ/mol (data not shown), which can be achieved upon heating.

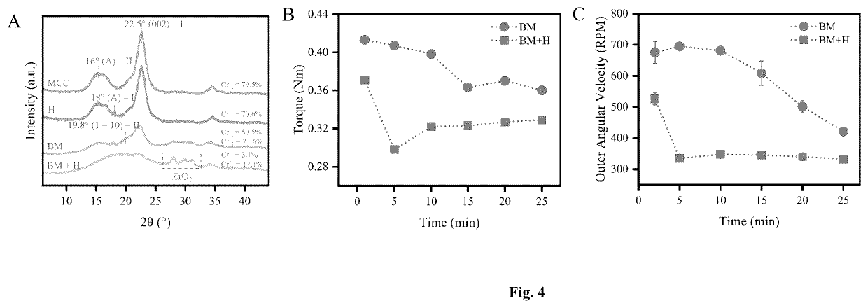

Physical factors also contribute to transetherification when heating is applied. As shown in the X-ray Crystallography (XRD) spectra (FIG. 4A), the untreated microcrystalline cellulose (MCC) mainly exhibited crystalline cellulose I and amorphous cellulose II phases. Upon heating, the cellulose I crystalline index (CrI_{I}) decreased from 79.5% to 70.6%. After treating the sample with ball milling, crystalline cellulose I phase was amorphized (CrI_{I}=50.5%), with an amorphous portion crystallizing to cellulose II (CrI_{II}=21.6%) due to the presence of inherent moisture during milling. The sample treated with ball milling+heating (BM+H) showed amorphization with CrI_{I} reduced to 3.2% and CrI_{II} reduced to 17.10%. The results on crystallinity demonstrated that heating increased the milling effects in cellulose amorphization. ZrO₂ powder was also observed to be milled off from the milling balls, as indicated by the crystalline ZrO₂ peaks observed in the XRD spectra (2Θ=28.2° [110], 30.2° [−111] and 31.4° [111]). The X-ray Crystallography (XRD) results suggested that heating increased shearing effect inside the ball mill. As shown in FIG. 4B, the torque in the BM system was higher than upon ball milling+heating (BM+H).

Octanol has a viscosity that decreases with increasing temperatures, leading to reduced torque. In a viscous medium, this results in a damping effect on the balls and internal friction in ball interactions. As shown in FIG. 4D, when balls with a viscous film near the paddle were subjected to a stirring force and moved at a certain speed, the balls next to them experienced viscous drag by receiving kinetic energy and moving at a reduced speed. This results in a lower velocity reduction gradient in the balls located in the center relative to balls located closer to the wall. The velocity gradient is defined as the shear rate (s⁻¹), and a reduced shear rate corresponds to poorer milling efficiency. Therefore, as temperatures increases, viscosity decreases, the velocity gradient increases and a higher shearing effect results.

Ball movements near the wall were recorded under both ball milling (BM) and ball milling with heating (BM+H) conditions using a high-speed camera and the angular velocity was measured. As shown in FIG. 4C, with heating, the outer ball moved at a velocity of approximately 300 rpm compared to the paddle's driving velocity of 700 rpm from 5 minutes onwards. In contrast, without heating, the outer ball moved at a speed close to the driving velocity, remaining above 600 rpm until 15 minutes, and then decreasing to approximately 400 rpm at 25 minutes due to the internal heat generated during milling. This demonstrates that heating increases shearing effects and amorphization compared to when heating is not applied.

Amorphization by ball-milling could increase the reactivity of cellulose towards transetherification which is linked to the polymer's glass transition property. An amorphized polymer with a lower glass transition temperature (T_{g}) is more reactive due to higher molecular mobility and exhibits greater swelling when exposed to solvents or reactants. The glass transition temperatures (T_{g}) of the treated and untreated samples were measured by differential scanning calorimetry (DSC). As shown in FIG. 4E, after ball milling, the glass transition temperature (T_{g}) of cellulose decreased from 180° C. to 173° C., and with the application of heat, it further reduced to 165° C. These results suggest that the amorphization induced by heated ball milling increased transetherification of the substrate.

As shown herein, the extent of transetherification occurring between the plant-derived biomass and fatty alcohol can be altered by ball milling and temperature (FIG. 4E). When the method disclosed herein is performed under ball milling and heating simultaneously, the plant-derived biomass is shown to be amorphized (FIG. 4A) and a shearing effect on the reactants is exerted (FIGS. 4B and 4C).

Thus, in one example, the method as disclosed herein is performed under ball milling and heating. In one example, the ball milling of step iii is conducted at a temperature of at least 110° C., and a rotational speed of at least 500 rpm, or at least 700 rpm. In one example, the ball milling of step iii is conducted at a temperature of between 110° C. to 120° C., and a rotational speed of between 300 rpm to 900 rpm. In another example, the ball milling of step iii is conducted at a temperature of about 110° C. or about 120° C., and a rotational speed of about 300 rpm, about 400 rpm, about 500 rpm, about 600 rpm, about 700 rpm about 800 rpm, or about 900 rpm.

### Influence of Amphiphiles Structure on Micelle Formation

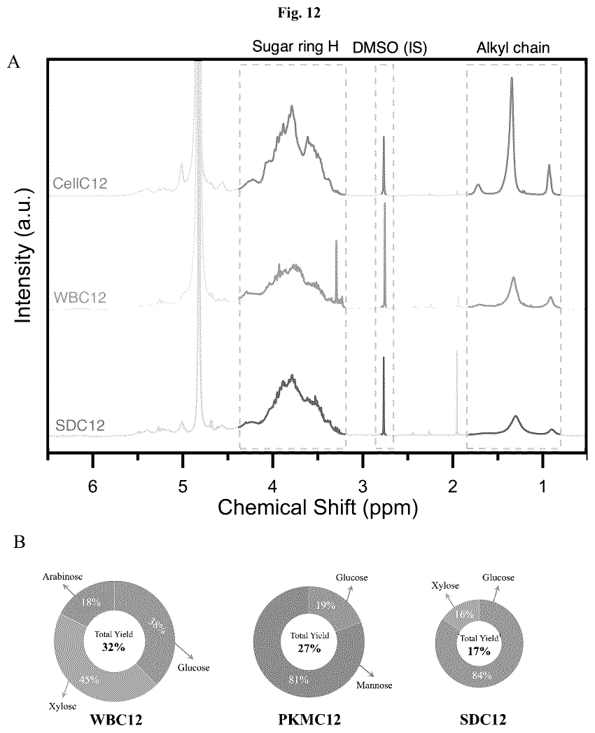

Biomass such as wheat bran (WBC), sawdust (SDC), and palm kernel meal (PKMC) were tested as substrates for producing oligosaccharide amphiphiles. The sugar utilization efficiency for these biomasses typically ranged from 17% to 32% (FIG. 12B). The amphiphiles derived from wheat bran showed similar oligomeric features to those from cellulose, with a sugar-to-alkyl (S:A) ratio of 16.8. In contrast, the amphiphilic compounds from sawdust and palm kernel meal had shorter sugar components, with S:A values of 1.2 and 1.9 (FIG. 12A), respectively, similar to the ratios found in common alkyl glucoside surfactants.

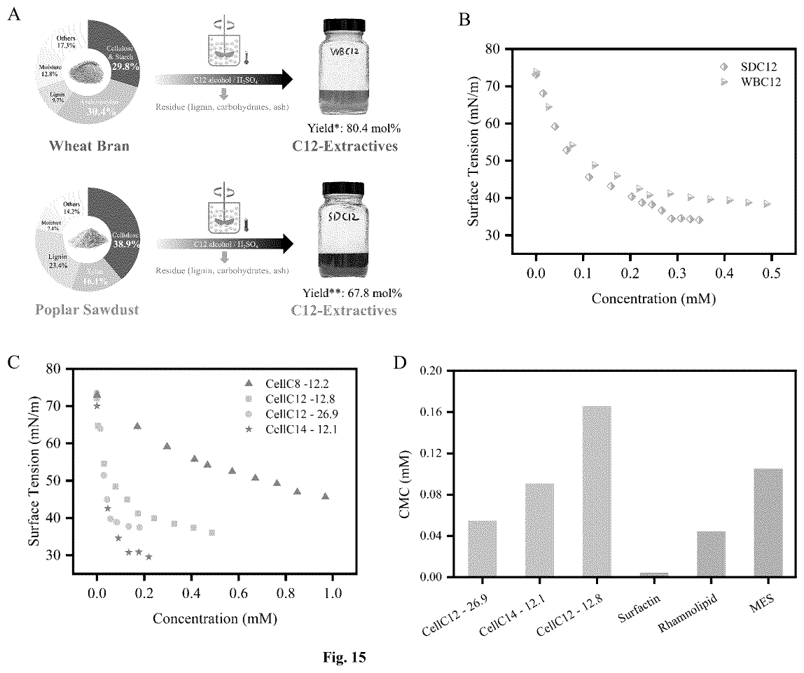

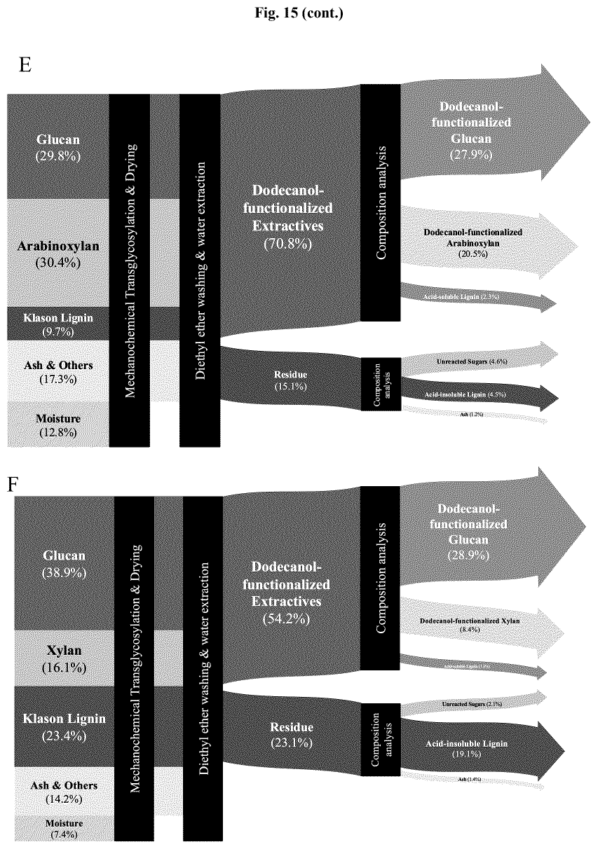

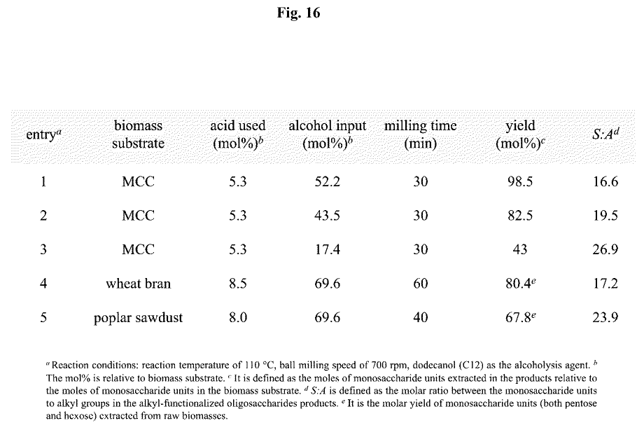

Mass balance analysis showed that 80.4 mol % and 67.8 mol % of monosaccharide units were obtained from wheat bran and sawdust respectively as C12-functionalised oligosaccharides (FIG. 15A, FIGS. 15E and 15F). The biomass residue comprises unreacted carbohydrates, acid-insoluble lignin, and ash. Amphiphiles extracted from wheat bran and sawdust showed higher DPₙ compared to those derived from cellulose (FIG. 12), with S:A of 17.2 and 23.9 (FIG. 16). FIG. 16 summarises the results of performing the method described herein on wheat bran and sawdust, and the variables which were changed in the method when used on wheat bran or sawdust. To achieve carbohydrate conversions compared to microcrystalline cellulose (MCC), wheat bran and poplar sawdust required increased amounts of acid catalyst, increased ball milling duration, and increased amounts of fatty alcohol (FIG. 16).

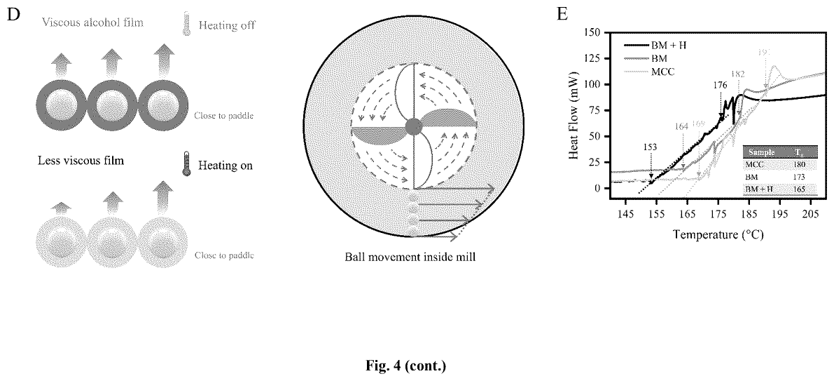

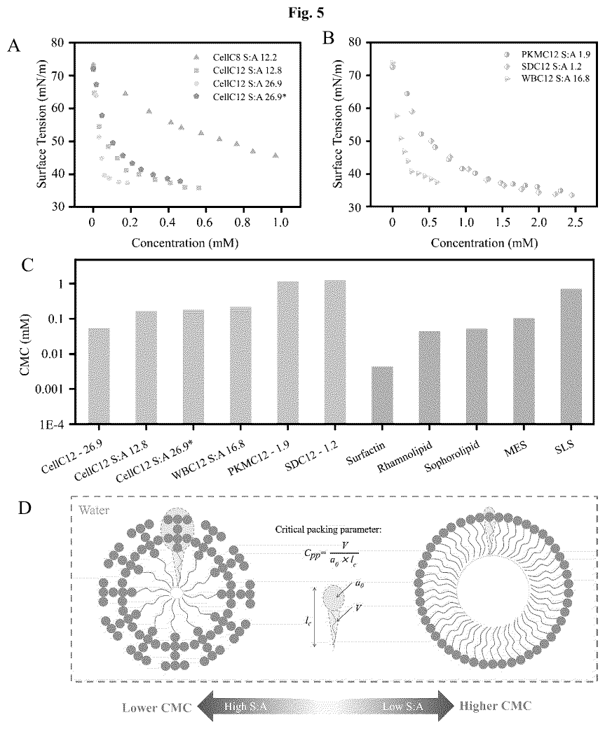

The water-air surface tension and micelle formation behaviour were tested using the Du Noüy ring method. As shown in FIGS. 5A and 15C, C12-alkylated products achieved an equilibrium surface tension of about 40 mN/m with a critical micelle concentration (CMC) below 0.3 mmol/L, indicating stable micelle formation. The C12 product, with a S:A ratio of 26.9, showed a critical micelle concentration (CMC) of 0.0547 mmol/L, unlike amphiphiles with a S:A ratio of 12.8, which had a CMC of 0.166 mmol/L. Products derived from sawdust and palm kernel meal required higher concentrations (>1 mmol/L) to form micelles compared to oligomeric amphiphiles from wheat bran (FIGS. 5B and 15B), which had a CMC of 0.221 mmol/L, as illustrated in FIG. 5B.

Next, the S:A 12.8 product was blended with cellooligosaccharides until it reached an S:A ratio close to 26.9, and its surface activity was analysed. The blend exhibited a surface tension reduction profile and CMC similar to S:A 12.8 product before blending with cellooligosaccharides (FIG. 5A).

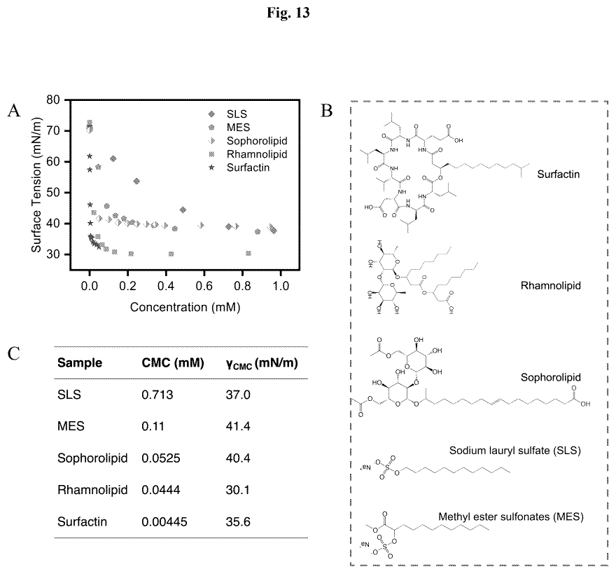

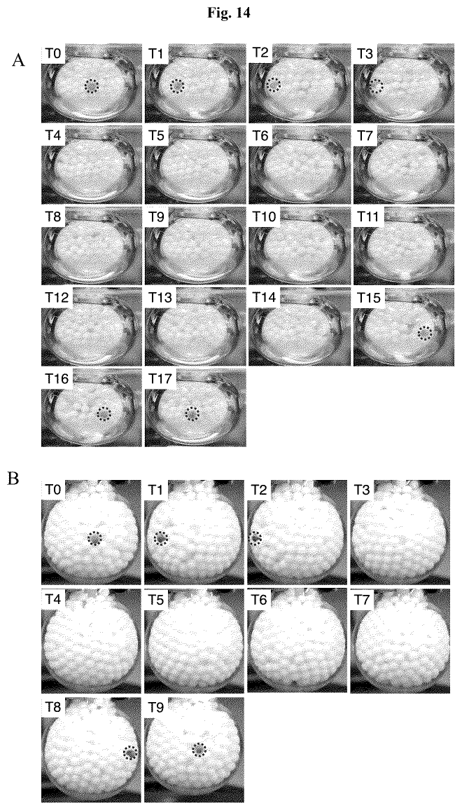

The CMC was also compared between oligosaccharide amphiphiles and conventional surfactants, as shown in FIGS. 5C and 15D. Structurally, SLS and MES have the smallest hydrophilic components relative to their hydrophobic alkyl chains. Among surfactin, rhamnolipid, and sophorolipid, surfactin has the bulkiest hydrophilic component due to its cyclic peptide group (FIG. 13). Surface activity results indicate that surfactin has the lowest CMC, while MES and SLS have the highest (FIG. 12).

As shown in FIG. 5D, the critical packing parameter (Cₚₚ) is inversely proportional to the effective surface area of the hydrophilic headgroup (a₀) and the maximum effective length (l_{c}). Incorporating bulkier hydrophilic sugar groups increases a₀ and l_{c}, leading to a reduction in Cₚₚ. A lower Cₚₚ promotes the formation of spherical micelles, the most compact configuration, requiring fewer amphiphilic molecules compared to cylindrical or other micelle morphologies, resulting in a lower CMC.

As shown herein, the method described herein can be performed with biomass as a reactant. In one example, the biomass is a plant-derived biomass. In another example, the plant-derived biomass is a carbohydrate.

In one example, the carbohydrate is a structural carbohydrate. Examples of structural carbohydrate can be, but is not limited to, cellulose, hemicellulose, or lignin. In one example, the structural carbohydrate can be, but is not limited to, cellulose or hemicellulose.

In another example, the carbohydrate is a non-structural carbohydrate. Examples of non-structural carbohydrate can be, but is not limited to, starch, glucose, fructose, galactose, sucrose, lactose, maltose, hexose, dextrose, mannose, pentose, xylose, or cellobiose. In one example, the storage carbohydrate is starch. In another example, the carbohydrate is sucrose. In yet another example, the carbohydrate is a product of an enzymatic digestion of starch or sucrose. Examples of biomass which contain a non-structural carbohydrate can be, but is not limited to, wheat bran, sawdust, or palm kernel meal.

To increase the rate or extent of transetherification reaction, the concentration of reactants can also be altered. In one example, the plant-derived biomass is present in the mixture of step i in an amount of at least 50 weight percent (wt %). In another example, the plant-derived biomass is present in the mixture of step i in an amount of at least 60 weight percent (wt %), at least 70 weight percent (wt %), or at least 80 weight percent (wt %). In another example, the plant-derived biomass is present in a ratio of 1:1 biomass to alcohol.

In another example, the fatty alcohol is present in the mixture of step i in an amount of between 20 wt % to 100 wt %. In another example, the fatty alcohol is present in the mixture of step i in an amount of about 20 wt %, 30 wt %, 40 wt %, 50 wt %, 60 wt %, 70 wt %, 80 wt %, or 90 wt %. In another example, the fatty alcohol is present in the mixture of step i in an amount of about 60 wt %.

### Extension to Longer-Chain Alcohols

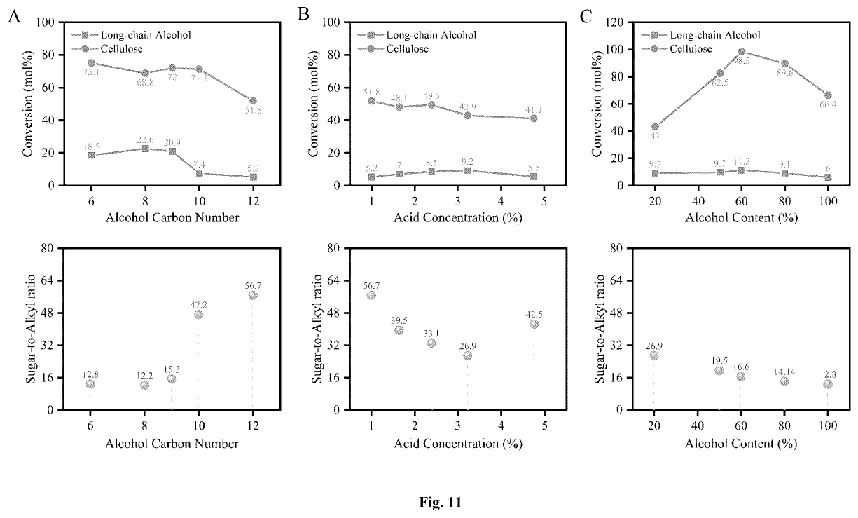

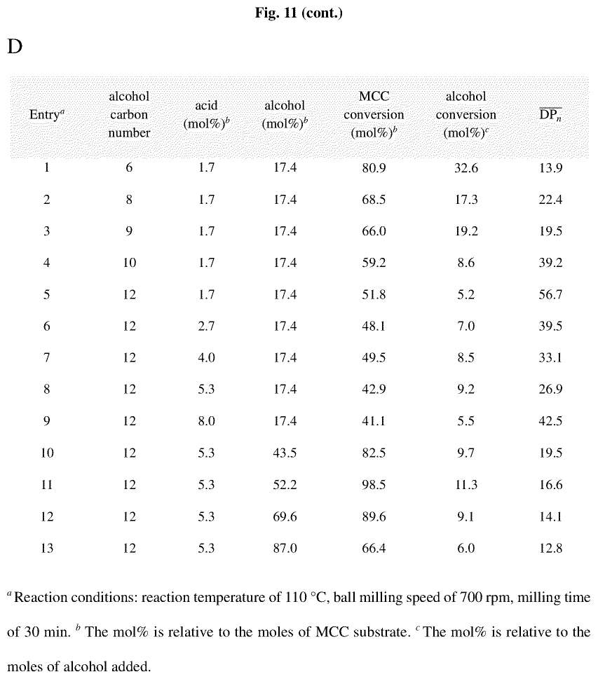

Alcohols comprising up to 13 carbons were tested for the production of oligosaccharide amphiphiles by the method described herein (FIGS. 11A and 11D). Alcohol conversion decreased (−65%) while the sugar-to-alkyl ratio increased (+208%) when the carbon number exceeded 10. Further increasing the carbon number to C12 resulted in a decrease in microcrystalline cellulose (MCC) conversion (−27%). Increasing the alkyl chain length reduced the conversion of both cellulose and fatty alcohols and increased the DPₙ. Elevating the acid catalyst dosage (from 1.7 to 5.3 mol %) increased the conversion of microcrystalline cellulose (MCC) and decreased DPₙ (entries 5-9, FIG. 11D). Increasing the amount of alcohol used in the method also increases conversion of microcrystalline cellulose (MCC) and decreased DPₙ, but can reduce MCC conversion under certain conditions (entries 8 and 10-13, FIG. 11D). Based on the results, the alcohol chain number was increased to 14 which resulted in DPₙ values ranging between 10.7 and 12.1.

The change in the degree of transetherification could be attributed to the decrease in reactivity of alcohols with more than 10 carbons towards nucleophilic attack by oxocarbenium (FIG. 10). The use of C12 as a transetherification agent also hindered microcrystalline cellulose (MCC) conversion. Besides the reduced reactivities of longer-chain fatty alcohol, the decrease in conversion can be due to the shear rate differences. Alcohols with higher carbon numbers tend to be more viscous, forming a viscous film on mill balls. As a result, the velocity gradient was decreased, leading to lower shearing rates for depolymerization.

As shown herein, fatty alcohols comprising at least 6 carbon atoms can be used in the method as described herein (FIG. 11A). In one example, the fatty alcohol comprises between 6 to 18 carbons. In another example, the fatty alcohol comprises between 6 to 12 carbons. In another example, the fatty alcohol comprises 6, 7, 8, 9, 10, 11, 12, 13, 14, 15, 16, 17, or 18 carbon atoms. The amount of fatty alcohol to be used can be adjusted depending on the number of carbon atoms in the fatty alcohol to increase the rate of transetherification (FIG. 11C). In one example, the fatty alcohol is present in the mixture of step i in an amount of between 20 wt % to 60 wt % when the fatty alcohol comprises between 6 to 10 carbon atoms. In another example, the fatty alcohol is present in the mixture of step i in an amount between 50 wt % to 60 wt % when the fatty alcohol comprises 11 or 12 carbon atoms.

The acid catalyst dosage used in the method described herein was increased from 1% to 4.8% (FIG. 11B). The conversion of C12 alcohol was increased by 77% and the sugar-to-alkyl ratio decreased (−53%) up to an acid dosage of 3.3%. A further increase in acid dosage beyond 3.3% decreased transetherification. The increase in acid addition also caused a monotonic reduction in microcrystalline cellulose (MCC) conversion and produced a darker product colour.

Increasing the alcohol content increases viscosity and decreases glycosidic bond cleavage. Consequently, increasing the alcohol content from 20 wt % (17.5 mol %) to 100% resulted in a plateau in microcrystalline cellulose (MCC) conversion at 98.5% with 60 wt % C12 alcohol usage (FIG. 11C). This plateau is possibly attributed to the balance between increased transetherification and decreased shearing effect. The higher availability of alcohol decreased the sugar-to-alkyl ratio to 12.8, comparable to the result obtained with C8 alcohol. Thus, 98.5% microcrystalline cellulose (MCC) depolymerization is achieved with C12 alcohol under specific acid catalyst dosages and alcohol content.

Thus, to increase the rate or extent of transetherification reaction, the concentration of the acid catalyst can be altered, such as depending on the number of carbon atoms in the fatty alcohol. It is shown herein that altering the concentration of the acid catalyst depending on the number of carbon atoms in the fatty alcohol alters the extent of transetherification (FIG. 11B). Thus, in one example, the acid catalyst is present in the mixture in an amount of between 1 wt % to 5 wt %. In another example, the acid catalyst is present in the mixture in an amount of about 1 wt %, 2 wt %, 3 wt %, 4 wt %, or 5 wt %.

The method as described herein is a solvent-free method in that it can be performed without a solvent. The method can be performed with a mixing agent instead. It is understood that any substance with properties suitable for use as a mixing agent can be used. For example, such substances should have a boiling point sufficiently low that it can be evaporated prior to the alcoholysis reaction in step iii. A low boiling point can be, for example, a boiling point that is lower than 100° C. Thus, in one example, the mixing agent has a boiling point of less than 100° C. In another example, the substance is polar. In yet another example, the substance can be an organic compound. Thus, in one example, any polar, organic compounds with a low boiling point can be used. Examples of mixing agents can be, but are not limited to, diethyl ether, ethyl acetate, di-n-propyl ether, di-n-butyl ether, di-isopentyl ether, acetone, ethanol, methanol, ethyl acetate, or any combinations thereof. In one example, the mixing agent is diethyl ether.

The mixing agent can be evaporated by means of rotary evaporation, or by evaporation under atmospheric pressure and heating. In one example, the evaporation is performed at a temperature above the boiling point of the mixing agent.

To increase the extent of transetherification reaction occurring in the method described herein for obtaining an oligosaccharide amphiphile from biomass, variables can be adjusted in the method such as, for example, the use of ball milling, heating, a mixing agent, or the amount of acid catalyst or fatty alcohol. In one example, the mixture of step i comprises diethyl ether; and step iii is conducted at a temperature of between 110° C. to 120° C., and a ball milling speed selected from the group consisting of between 300 rpm to 900 rpm. In another example, the fatty alcohol in the mixture of step i is present in an amount of between 20 wt % to 60 wt % when the fatty alcohol comprises between 6 to 10 carbon atoms, or in an amount of between 50 wt % to 60 wt % when the fatty alcohol comprises 11 or 12 carbon atoms; the mixture of step i further comprises: sulfuric acid at a concentration of about 1%, and dimethyl ether; and the ball milling of step iii is conducted at a temperature of about 110° C., and a rotational speed selected from the group consisting of about 300 rpm, about 400 rpm, about 500 rpm, about 600 rpm, about 700 rpm, about 800 rpm, or about 900 rpm.

It is thus shown that the method as described herein can obtain an oligosaccharide amphiphile from a plant-derived biomass in a solvent-free manner. Accordingly, disclosed herein is a method of obtaining an oligosaccharide amphiphile, the method comprising the steps of: i. providing a mixture comprising: a plant-derived biomass; a fatty alcohol; and an acid catalyst; ii. subjecting the mixture of step i to rotary evaporation, thereby obtaining a phase; iii. subjecting the phase of step ii to ball milling at a temperature of at least 90° C.; and mixing the phase of step iii with water and purifying the resulting mixture to obtain an oligosaccharide amphiphile.

To obtain a purified oligosaccharide amphiphile from the method as described herein, after step iii of the method, the resulting phase can be purified by any purification methods known in the art. Examples of purification methods can be, but are not limited to, extraction with water, centrifugation, filtration, vacuum evaporation, distillation, or any other methods which can purify a product, such as an oligosaccharide amphiphile from a chemical reaction. In one example, after step iii of the method, the resulting phase can be washed with a mixing agent (for example, diethyl ether), before dissolving in water. The dissolved product can subsequently be purified by centrifugation and filtration.

### Product Characterization

Microcrystalline cellulose (MCC), 25 mol % 1-octanol, and 1 wt % sulfuric acid were mixed in diethyl ether. This mixture was then subjected to rotary evaporation to uniformly impregnate the fatty alcohol and acid catalyst onto the microcrystalline cellulose (MCC). Subsequently, 200 mg of the resulting powder was transferred into a round-bottom flask pre-packed with 5 mm ZrO₂ milling balls. A stirring paddle was inserted into the flask, which was then placed inside an oil bath maintained at 110° C. The paddle was rotated at 500 rpm by a motor to achieve ball milling of the microcrystalline cellulose (MCC). After 30 minutes of milling, water was added to the flask to dissolve the products. These products were then neutralized, freeze-dried, and washed three times with ether to remove residual alcohol, and are referred to as ‘Cellulose-C8’ or ‘CellC8’.

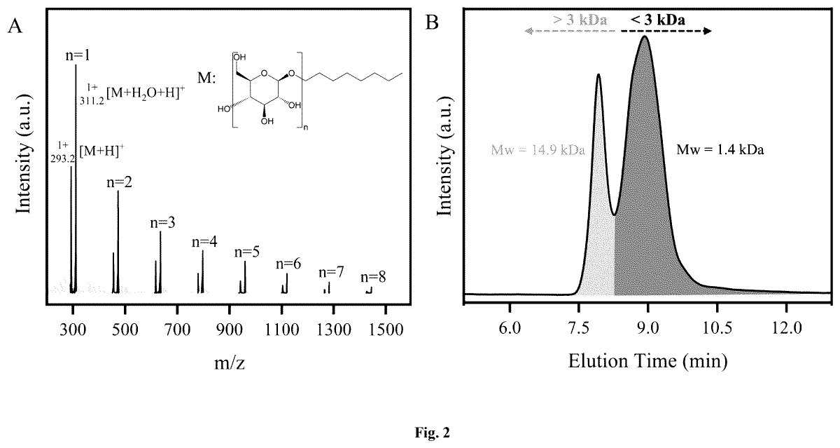

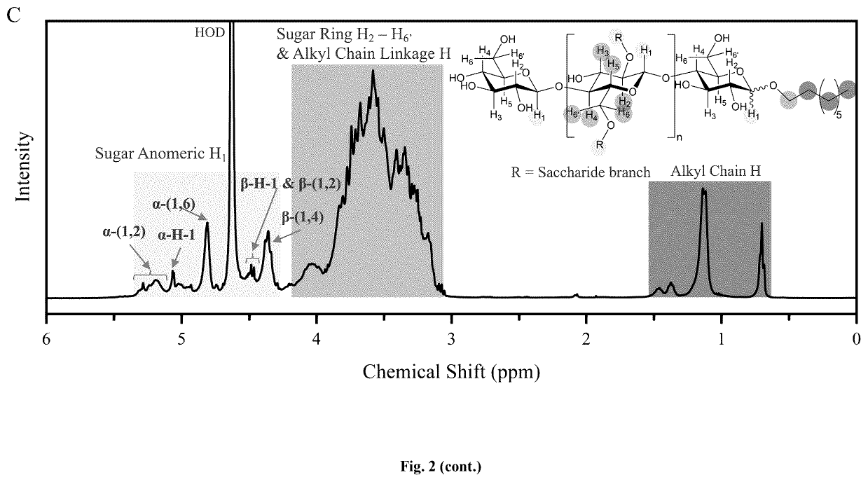

To characterize Cellulose-C8, it was dissolved in an acidified water-methanol solvent (1:1 volume ratio) and analyzed using electrospray ionization mass spectrometry (ESI-MS). The mass spectrum showed signals at m/z 293.2 and 311.2, identified as [(C₁₄H₂₈O₆)+H]⁺ and [(C₁₄H₂₈O₆)+H₂O+H]⁺, respectively (FIG. 2A). These peaks correspond to the amphiphilic products of octyl monoglucoside with a degree of polymerization (n) of one. Using ‘M’ to denote C₁₄H₂₈O₆, peaks at m/z 455.2 and 472.3 represent the amphiphilic dimer. Following this approach, ESI-MS displayed amphiphilic species up to the octamer (n=8). Additionally, peaks at m/z 325.1, 343.1, and 361.2 were identified as [(C₁₂H₂₂O₁₁)—H₂O+H]⁺, [(C₁₂H₂₂O₁₁)+H]⁺, and [(C₁₂H₂₂O₁₁)+H₂O+H]⁺, respectively. These correspond to disaccharides (n=2), or its anhydride not linked to an octyl chain. Similarly, saccharide compounds were identified up to the hexamer (n=6).

Gel permeation chromatography (GPC) was performed on products dissolved in water to analyse the molecular distribution (FIG. 2B). With approximately 3 kDa as the borderline, two peaks with number-averaged molecular weights (Mn) of 12.5 kDa and 0.51 kDa were identified. By comparing the peak areas, majority of the products were below 3 kDa, with the remainder consisting of oligosaccharide compounds with an average degree of polymerization (DP) of approximately 77.

Accordingly, disclosed herein is an oligosaccharide amphiphile obtained by the method as disclosed herein. In one example, the oligosaccharide amphiphile is branched. In another example, the oligosaccharide amphiphile has a degree of polymerization of at least 3. In another example, the oligosaccharide amphiphile is at least 90% soluble between 3° C. to 45° C. as measured by the amount of undissolved oligosaccharide amphiphile after dissolving in water. In another example, the oligosaccharide amphiphile has a sugar-to-alkyl (S:A) ratio of between 10 to 28.

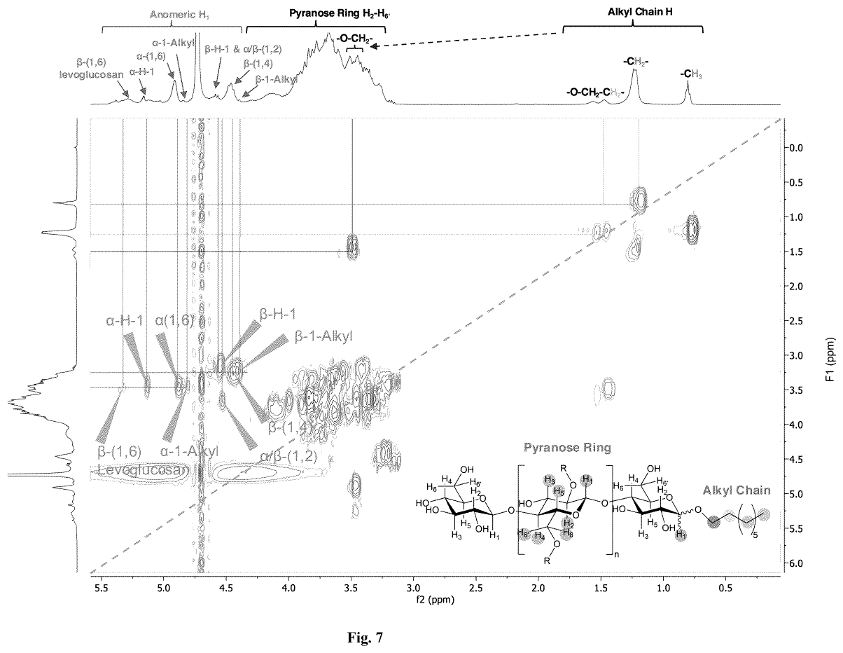

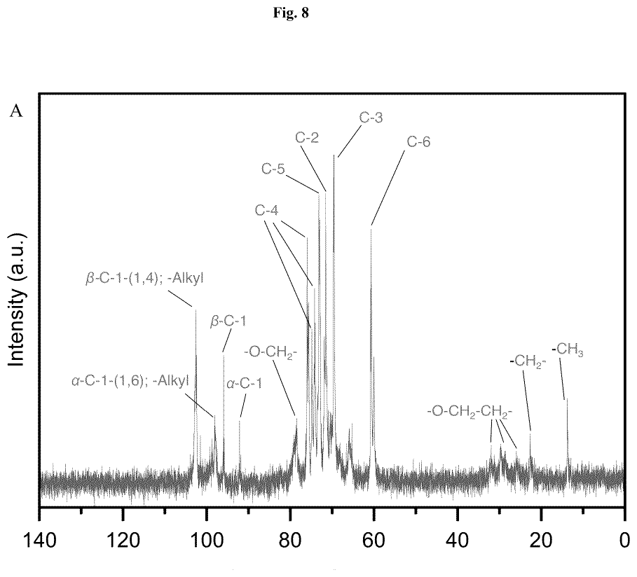

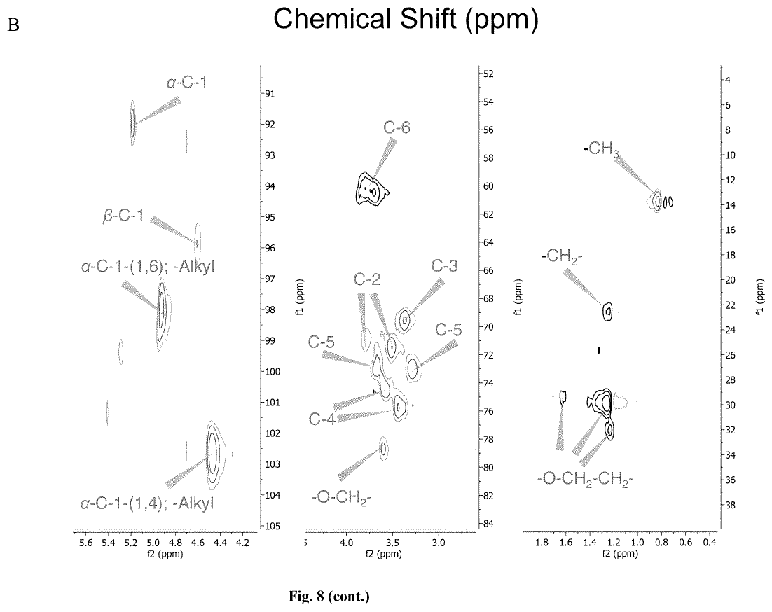

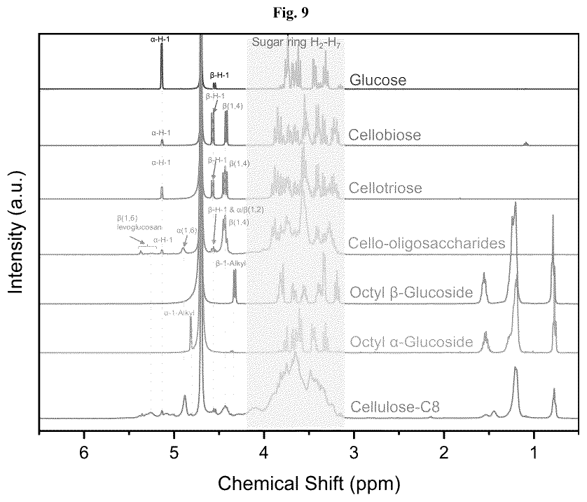

To further elucidate the chemical structure of the glycosylated product, ¹H and ¹³C NMR (FIG. 8A), ¹H-¹³C (HSQC) (FIG. 8B) and ¹H-¹H (COSY) (FIG. 7) correlation spectroscopies were conducted. Additionally, a comparative NMR spectra analysis of the product with other oligosaccharides and alkyl monoglucoside compounds was performed (FIG. 9). The ¹H NMR spectrum (FIG. 2C) shows that in the region between 1.0 and 2.0 chemical shift (ppm), chemical shifts observed at 0.70 ppm, 1.12 ppm, 1.37 ppm, and 1.46 ppm were ascribed to the protons on the glycosylated hydrocarbon chain (—CH₂ and —CH₃ groups), except for the protons attached to the carbon adjacent to the glycosidic bond oxygen (—O—CH₂—). These protons should be more de-shielded (>3 ppm) due to the adjacent glycosidic bond 0 atom and also have H—H correlation with alkyl protons (<2 ppm). Hence, according to the HSQC analysis, they were detected at 3.47 ppm and 3.50 ppm. In the region between 3.5 and 4.5 chemical shift (ppm), overlapping peaks corresponding to H₂, H₃, H₄, H₅, H₆, and H_{6′} of the pyranose ring are observed between 3.04 ppm to 4.12 ppm. The region between 4.6 to 6.0 chemical shift (ppm) contains only the pyranose anomeric proton (H₁) due to the strong de-shielding effect of the pyranose hemiacetal. The data provides structural details about the amphiphiles' saccharide components, such as the (1,4), (1,2), and (1,6) glycosidic linkages connecting the adjacent saccharide units.

Based on the results from ESI-MS, GPC, and NMR analyses, it was determined that the products formed through the method as described herein comprise oligosaccharides as the hydrophilic head which is derived from cellulose, and a hydrophobic alkyl tail which is derived from fatty alcohol. The connection between these components occurs at the anomeric end of the oligosaccharide head via an α/β glycosidic bond. The structure of the oligosaccharide part is complex and highly branched, as evidenced by the presence of α/β-(1,2) and α-(1,6) glycosidic bonds. The branch formation could be due to oxocarbenium sites generated during depolymerization, which react with primary or secondary hydroxyl groups located on the pyranose unit (FIG. 10). Additionally, the detection of some saccharide compounds indicates a degree of hydrolysis that can be due to moisture in the biomass (FIG. 10). The oligosaccharide amphiphiles were thus produced from cellulose using ball milling with heating.

### Surfactant Performances

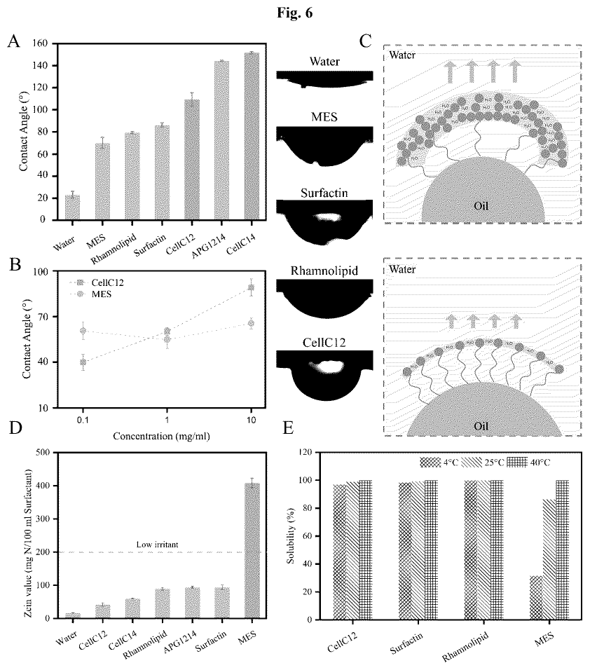

The oil de-wetting properties, skin irritation potential, and solubility were next analysed and compared to conventional surfactants. The oil de-wetting properties were measured by the contact angle of a sunflower oil droplet submerged in an aqueous surfactant solution on a polypropylene surface. Effective surfactants facilitate oil de-wetting from the surface, resulting in a larger contact angle. As illustrated in FIG. 6A, the CellC12 exhibited a contact angle ˜90° at a concentration of 10 mg/ml compared to water, MES, surfactin, and rhamnolipid at the same concentration. MES was next compared with the CellC12 across various concentrations (FIG. 6B). The contact angle for MES remained around 60° at concentrations of 0.1, 1.0, and 10 mg/ml. The contact angle for CellC12 decreased to ˜40° as the concentration was reduced from 10 to 0.1 mg/ml.

As shown in FIG. 6C, oil de-wetting requires interaction between the oil droplet and the aqueous phase, which is facilitated by the hydrophilic head groups of surfactant molecules. The oligosaccharide components in CellC12, which possess multiple hydroxyl groups, form hydrophilic interactions with surrounding water molecules through hydrogen bonding. Moreover, the branching structure of these oligosaccharides has increased water solubility compared to linear oligosaccharide chains, thereby increasing surfactant-water interactions.

It is also shown herein that the oligosaccharide amphiphile obtained by the method as disclosed herein has increased oil de-wetting properties compared to conventional surfactants (FIG. 6A) and has increased water solubility even across different temperatures (FIGS. 6C and 6E), where water solubility is measured by the amount of undissolved oligosaccharide amphiphile after dissolving in water. The oil de-wetting properties of the oligosaccharide amphiphile described herein is comparable to a conventional surfactant MES (FIG. 6B). Accordingly, disclosed herein is a surfactant comprising an oligosaccharide amphiphile as disclosed herein.

As shown in FIG. 6E, the water solubility of CellC12 and other conventional surfactants was measured by mixing 20 wt % surfactant in water and measuring the insoluble residue at 4° C., 25° C., and 40° C. The results showed that amphiphiles derived from biomass exhibited higher water solubility than MES across all temperatures. In contrast, MES was only fully water-soluble at 40° C., with its solubility decreasing to 31.6 wt % at 4° C.

It is also shown herein that the oligosaccharide amphiphile obtained by the method as disclosed herein is capable of forming micelles (FIGS. 5A and 5B). Furthermore, the critical micelle concentration (CMC) of the oligosaccharide amphiphiles obtained by the method as disclosed herein is higher than conventional surfactants, indicating the formation of larger micelles than conventional surfactants (FIG. 5C). Accordingly, disclosed herein is a micelle comprising an oligosaccharide amphiphile as disclosed herein. Disclosed herein is also micelle as disclosed herein or a surfactant as disclosed herein for use in personal care and/or in home care products.

The Zein test was conducted on CellC12 and other conventional surfactants, including MES, rhamnolipid, and surfactin, to assess their irritation potential. The Zein test measures the solubility of yellow corn protein, analogous to keratin in skin and hair, in surfactant solutions. The result is expressed as the nitrogen weight number dissolved, known as the zein value. As shown in FIG. 6D, all surfactants derived from biomass exhibit zein values below 100, indicating poor protein solubility and low skin irritation potential. In contrast, MES has a zein value of 400, indicating strong irritation. Cellulose-derived amphiphile shows a zein value of ˜20, which is lower than surfactin and rhamnolipid.

The oligosaccharide amphiphile as described herein is thus shown to have a lower irritation potential compared to conventional surfactants, where a parameter for the irritation potential of a substance to hair and skin is the zein value. As shown in FIG. 6D, the zein value of the oligosaccharide amphiphile as described herein is lower than conventional surfactants, demonstrating its low irritation potential. Thus, in one example, the oligosaccharide amphiphile has a zein value of less than 100, less than 40, less than 30, or less than 20.

The lowered irritation potential of the claimed oligosaccharide amphiphile compared to conventional surfactants renders it suitable for use as a composition, for example in personal care or household use. Accordingly, disclosed herein is a composition comprising a micelle or a surfactant comprising an oligosaccharide amphiphile as disclosed herein.

Compositions comprising a micelle or a surfactant comprising the oligosaccharide amphiphile as disclosed herein can be formulated depending on its intended use, where suitable formulations would be known by a skilled person.

The composition described herein can be formulated for personal care which can be, but are not limited to, shampoos, conditioners, body wash, hand soap, bar soaps, facial cleansers, cosmetics, lotions, or any other personal care compositions which require a surfactant for mixing immiscible substances. In one example, disclosed herein is a personal care product comprising a micelle as disclosed herein or a surfactant as disclosed herein.

The composition described herein can be formulated for household use which can be, but are not limited to, dishwashing liquid, clothing detergent, cleaning liquids, or any other household products where a surfactant is required for mixing immiscible substances. In one example, disclosed herein is a home care product comprising a micelle as disclosed herein or a surfactant as disclosed herein.

In another example, disclosed herein is a use of a micelle as disclosed herein or a surfactant as disclosed herein in the manufacture of a personal care and/or a home care product.

Thus, a method of obtaining an oligosaccharide amphiphile from a plant-derived biomass has been described herein. The method as described herein is shown to be solvent-free and was shown to convert a plant-derived biomass and a fatty alcohol to an oligosaccharide amphiphile. The resulting oligosaccharide amphiphile is shown to be branched oligosaccharides modified with an alkyl tail at the anomeric end of the saccharide chain. Furthermore, in contrast to conventional carbohydrate-based surfactants which conventionally has a degree of polymerization (DP) up to 2, the oligosaccharide amphiphile obtained in the claimed method has a of degree of polymerization (DP) up to 8, which is achieved by partial depolymerization during ball milling. The method as described herein is also shown to be able to be applied to alcohols having up to 12 carbon atoms. The resulting oligosaccharide amphiphiles demonstrated surfactant properties, such as being able to decrease water surface tension, form micelles, and oil de-wetting, while having low irritation potential.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

As used in this application, the singular form “a,” “an,” and “the” include plural references unless the context clearly dictates otherwise. For example, the term “a genetic marker” includes a plurality of genetic markers, including mixtures and combinations thereof.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as between 110° C. to 120° C. should be considered to have specifically disclosed sub-ranges such as from 110° C. to 111° C., 110° C. to 112° C., 110° C. to 113° C., 115° C. to 116° C. etc. as well as individual numbers within that range, for example, 110° C., 111° C., 112° C., 113° C., 114° C., 115° C., 116° C., 117° C., 118° C., 119° C., 120° C. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

### Experimental Section

### Chemicals and Materials

Microcrystalline cellulose was purchased from Alfa Aesar. H₂SO₄ (≥98.0%), NaOH (≥98.0%), anhydrous diethyl ether (≥99.0%), 1-hexanol (≥99.0%), 1-octanol (≥99.0%), 1-nonanol (≥98.0%), 1-decanol (≥98.0%), 1-dodecanol (≥98.0%), D-(+)-Glucose (≥99.5%), D-(+)-Xylose (≥99.0%), L-(+)-Arabinose (≥99.0%), D-(+)-Mannose (≥99.0%), and D-(+)-Cellobiose (≥99.0%) were acquired from Sigma-Aldrich. Cellotriose (≥95.0%) was obtained from Megazyme. Octyl β-glucoside (≥98.0%) and octyl α-glucoside (≥98.0%) were from BLDpharm. Sawdust and sunflower oil were purchased from grocery stores. Palm kernel meal, wheat bran, and conventional surfactants were supplied by Wilmar International Limited. All chemicals and reagents were used without further purification.

### General Procedures

In a typical experiment, 1 g of biomass was mixed with fatty alcohol (20-100 wt %) and H₂SO₄ (1-5 wt %) in diethyl ether for 15 minutes. The slurry was then subjected to rotary evaporation under reduced pressure to remove ether and achieve a homogeneous solid or paste-like phase. Subsequently, 200 mg of this mixture was transferred into a 50 mL round-bottom flask (the mill jar), and 400 ZrO₂ balls (5 mm) were added to fill approximately ⅔ of the flask's volume. A PTFE stirring paddle with adjustable speed was inserted, and the setup was immersed in a preheated oil bath at a constant temperature. After milling for 40 minutes, the jar was water-cooled to room temperature. The product was extracted with ultra-pure water, centrifuged at 8000 rpm to remove unreacted biomass, filtered using a 0.22 μm PES filter, neutralized to pH 7 with 5M NaOH, and freeze-dried. The resulting crude product was purified by washing with diethyl ether to remove residual fatty alcohol. All experiments were performed in triplicate. The resulting three sets of product were blended in water and freeze-dried before characterization and quantification.

### Characterization Methods

¹H and ¹³C NMR spectra, along with ¹H-¹³C HSQC and ¹H-¹H COSY correlation spectroscopies, were obtained for samples dissolved in D₂O using a Bruker Ascend 400 MHz NMR spectrometer. DMSO was utilized as the internal standard for quantifying the moles of alkyl and sugar components in oligosaccharide amphiphiles derived from cellulose biomass. ESI-MS analysis was conducted on a Bruker MicroTOF-Q system. Samples were dissolved in an acidified water-methanol (1:1) mixture and injected at a flow rate of 10 μL/min. GPC was performed using a 1260 Infinity II Multidetector GPC/SEC System equipped with a PL aquagel-OH column (7.5×150 mm×3 m), with ultrapure water as the mobile phase. Sugar quantification for raw biomasses and their derived products was performed using an HPLC Shimadzu DGU-20A5R system, equipped with a Hi-Plex H column (7.7×300 mm×8 μm), operating at a temperature of 60° C. A refractive index detector was used, maintained at the same temperature for detection. The mobile phase was a 5 mM aqueous H₂SO₄ solution, with a flow rate of 0.6 mL/min. The differential scanning calorimetry (DSC) scan was performed using a Perkin Elmer DSC8000 system with a heating program set to 10° C. per minute, ranging from 0 to 220° C.

### Quantification Methods

Molar conversions of cellulose and alcohol were determined from ¹H NMR spectra using quantitative NMR with DMSO as the internal standard (IS). The moles of reacted alcohol and cellulose were calculated by comparing the alkyl proton peaks (0.80-1.80 ppm) and sugar ring proton peaks (3.04-4.12 ppm) with DMSO proton peaks (2.75 ppm). For products derived from biomasses, the quantification of product sugars was performed using HPLC method according to NREL Determination of Structural Carbohydrates and Lignin in Biomass.

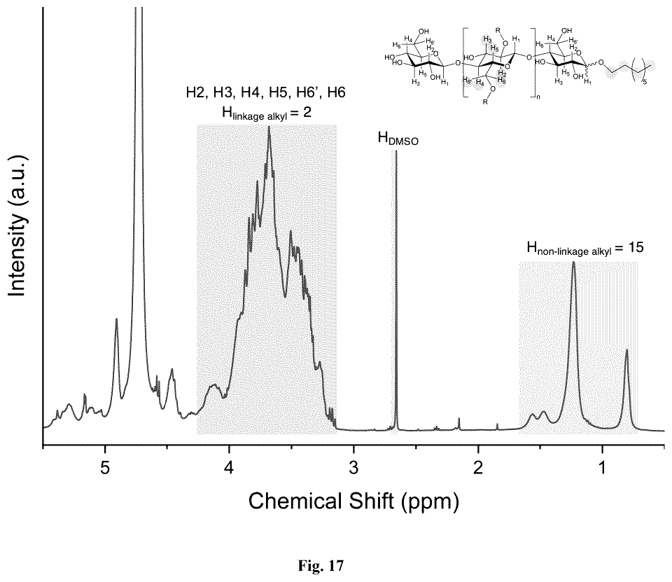

An example of the quantification of each fraction in the product via qNMR (FIG. 17) is as follows: First, the S:A ratio is determined by assigning the integral area corresponding to the non-linkage alkyl protons (15 protons for CellC8) to match its theoretical proton count. Next, the integral area (I_{H2-H6}) for the monosaccharide unit protons (H2 to H6) is calculated by subtracting the contribution from the linkage alkyl protons (2 protons) from the total overlapping integral region. This adjustment accounts for the spectral overlap between the linkage alkyl protons and the monosaccharide unit protons. If the integral value for protons H2 to H6 is calculated to be greater than 6 (the proton number associated with one monosaccharide unit, N_{H2-H6}), this indicates the presence of oligomeric structures. The S:A ratio can then be determined using Equation (S1).

$$S : A = \frac{{I}_{H 2 - H 6}}{{N}_{H 2 - H 6}} = \frac{{\sum }_{i = 2}^{6} {I}_{Hi} - 2}{6} \qquad ( S 1 )$$

Next, the molar quantity of glucose units incorporated into the oligomeric components (mol_{glucose units incorporated}) is calculated by comparing its integral to that of a known-quantity internal standard (I_{DMSO}) using Equation (S2). The number of protons in each DMSO molecule (N_{DMSO}) is 6

$${mol}_{glucose units incorporated} = \frac{{I}_{H 2 - H 6}}{{I}_{DMSO}} \times \frac{{N}_{DMSO}}{{N}_{H 2 - H 6}} \times {mol}_{DMSO} \qquad ( S 2 )$$

Similarly, the molar quantity of reacted alcohol can be calculated using the non-linkage alkyl protons, as shown in Equation (S3)

$${mol}_{alcohol incorporated} = \frac{{I}_{non - linkage alkyl}}{{I}_{DMSO}} \times \frac{{N}_{DMSO}}{{N}_{non - linkage alkyl}} \times {mol}_{DMSO} \qquad ( S 3 )$$

$${X}_{cellulose} = \frac{{mol}_{glucose unit incorporated}}{{mol}_{reactant cellulose}} \qquad ( Formula 1 )$$

$${X}_{alcohol} = \frac{{mol}_{alcohol incorporated}}{{mol}_{reactant alcohol}} \qquad ( Formula 2 )$$

X_{cellulose} is the molar ratio of glucose units (in polymerized saccharide form, molar mass=162.14 g/mol) incorporated into the products as the oligosaccharide components (mol_{glucose incorporated}) to the initial moles of cellulose added (mol_{reactant} cellulose). Similarly, X_{alcohol} is the molar ratio of alcohol incorporated into the products as the alkyl components (mol_{alcohol incorporated}) to the initial moles of alcohol added (mol_{reactant alcohol}).

For products derived from biomass, the overlapping proton signals of saccharide rings (3.04-4.12 ppm) from different monosaccharide units complicate the direct analysis of the saccharide composition. To address this, the monosaccharide profiles of the products and the biomasses were determined by complete acid hydrolysis, followed by HPLC to quantify the monosaccharides. This procedure adhered to the NREL Standard Method for the Determination of Structural Carbohydrates and Lignin in Biomass. Using these results, the yield was calculated via Formula 3, and the sugarto-alkyl molar ratio (S:A) of the extracted products was determined via Formula 4.

$$Yield = \frac{{mol}_{C 5 \& C 6 monosaccharide units in products}}{{mol}_{C 5 \& C 6 monosaccharide units in biomass}} \qquad ( Formula 3 )$$

$$S : A = \frac{{mol}_{C 5 \& C 6 monosaccharide units}}{{mol}_{alkyl}} \qquad ( Formula 4 )$$

### Crystallinity Index

The crystallinity index of both treated and untreated cellulose samples was determined using XRD spectra. Measurements were taken over a range of 10° to 90° using a Bruker D8 Advance X-ray diffractometer with Cu Kα radiation (λ=1.5406 Å, 40 kV, 20 mA). The crystallinity index (CrI) was calculated according to Segal's method, as shown in Formula 5 and 6 below:

$${CrI}_{I} = \frac{{I}_{002} - {I}_{AI}}{{I}_{002}} \times 100 \% \qquad ( Formula 5 )$$

$${CrI}_{II} = \frac{{I}_{1 - 10} - {I}_{AII}}{{I}_{1 - 10}} \times 100 \% \qquad ( Formula 6 )$$

where I₀₀₂ and I₁₋₁₀ correspond to the highest intensities of the (002) and (1-10) lattice planes for cellulose I and cellulose II, observed at 2θ=22.5° and 19.8°, respectively. Similarly, I_{AI} and I_{AII} refer to the diffraction intensities for the amorphous phases in cellulose I and cellulose II, noted at 2θ=180 and 160 respectively.

### Measurement of Rotation Torque

The torque of the system was measured by a power meter that measures the real-time power consumed by the motor driving the paddle's motion. The torque exerted on the paddle is calculated by:

$$T = \frac{P \times 60}{2 π \times RPM} \qquad ( Formula 7 )$$

where T is the torque value in Nm, P is the power consumed by the motor in W, and RPM is the rotational angular velocity of the paddle in revolutions per minute.

### Measurement of Outer Ball Angular Velocity

The movement of rotating balls near the outer surface of the transparent mill jar was recorded using a Fujifilm XT-5 camera. A black-colored reference ball was placed inside the jar together with other white-colored ZrO₂ balls. Upon initiation of rotation, the camera, operating in slow-motion mode at 240 fps, documented the movement of the reference ball within the mill. To ensure a fair comparison, only the movements of balls near the central horizontal line of the mill jar were analyzed. Each recorded motion represented a complete 3600 rotation of the reference ball. The angular velocity was calculated by dividing the angle rotated by the time taken. Sample frames captured with 1/240 s time interval for the ball milling (BM) and ball milling+heating (BM+H) systems are presented in FIG. 13.

### Surface Tension Measurement

The surface tension of surfactant aqueous solutions was measured using a Sigma Force Tensiometer 703D with a platinum Du Noüy ring. A sample vessel was filled with 70 mL of ultrapure water to record the initial surface tension. Then, 0.1-1.0 mL of 1 wt % surfactant solution was added and stirred vigorously. After reaching equilibrium, the surface tension was recorded three times, and the average value was taken. The surface tension is expressed on a molar basis, defined by the molar concentration of the hydrophobic alkyl tail, as oligosaccharide amphiphiles contain only one alkyl tail per molecule.

### Oil De-Wetting Test

The oil-wetting performance was measured by the contact angle of an oil droplet on a polypropylene surface using an OCA25 goniometer. In a typical test, a transparent sample vessel was filled with 30 mL of the test surfactant solution. A polypropylene slab was suspended in the liquid, and a 2.00 μL drop of sunflower oil was injected onto the lower surface of the submerged slab using a U-shaped needle. After reaching equilibrium, the contact angle of the oil droplet on the slab was measured. All analyses were performed in triplicate.

### Zein Solubilization Test

Zein powder was used for the zein value test. A 16 mL aliquot of 1 wt % surfactant solution was placed in a 20 mL vial, pre-warmed at 40° C. and 100 rpm for 30 minutes. Then, 0.5 g of zein powder was added and shaken vigorously. The vials were returned to the water bath at 40° C. and 100 rpm for 1 hour. After cooling to room temperature, the samples were centrifuged at 8000 rpm for 15 minutes. The clear middle layer was extracted and filtered through a 0.22 μm PES filter. Zein concentration was measured using a UV-vis spectrometer. For calibration, 3.5 g of zein powder was dissolved in a 100 mL volumetric flask with a 70% alcohol and 30% water mixture, stirred overnight to obtain a 35 mg/mL solution. This solution was diluted to create standards of 25, 15, 10, and 5 mg/mL, each filtered before UV analysis. A surfactant solution served as the UV reference. A UV scan (800-200 nm) recorded absorbance at 445 nm. UV absorbance (X) was plotted against zein concentration (Y, mg/mL). Nitrogen in zein (14.5% N) was analyzed by elemental analysis. The zein value was calculated as Y (mg/mL)×14.5, representing the mg of nitrogen in 100 mL surfactant solution. All analyses were performed in triplicate.

### Solubility Test

Solubility was assessed by dissolving 0.4 g of surfactant in 2.0 mL of water. The mixture was incubated at 4° C., 25° C., and 40° C. with shaking for 2 hours. Undissolved solids were then separated by centrifugation at each respective temperature and weighed after drying. Solubility was calculated by subtracting the weight of the undissolved solids from the initial surfactant weight, and the result was reported as a weight percentage.

1. A method of obtaining an oligosaccharide amphiphile, the method comprising the steps of:
i. providing a mixture comprising:
a plant-derived biomass;
a fatty alcohol; and
an acid catalyst;
ii. subjecting the mixture of step i to rotary evaporation, thereby obtaining a phase;
iii. subjecting the phase of step ii to ball milling at a temperature of at least 90° C.; and
iv. mixing the phase of step iii with water and purifying the resulting mixture to obtain an oligosaccharide amphiphile.

2. The method of claim 1, wherein step iii is conducted at a temperature of between 110° C. to 120° C., or wherein step iii is conducted at a temperature of about 110° C.

3. (canceled)

4. The method of claim 1, wherein the ball milling of step iii is conducted at a rotational speed of between 200 rpm to 1000 rpm, or wherein the ball milling of step iii is conducted at a rotational speed of about 300 rpm, about 400 rpm, about 500 rpm, about 600 rpm, about 700 rpm, about 800 rpm, or about 900 rpm.

5. (canceled)

6. The method of claim 1, wherein the ball milling of step iii is conducted at a temperature of between 110° C. to 120° C., and a rotational speed of between 300 rpm to 900 rpm, or wherein the ball milling of step iii is conducted at a temperature of about 110° C. or about 120° C., and a rotational speed selected from the group consisting of: about 300 rpm, about 400 rpm, about 500 rpm, about 600 rpm, about 700 rpm about 800 rpm, or about 900 rpm.

7. (canceled)

8. The method of claim 1, wherein the plant-derived biomass comprises a structural or a non-structural carbohydrate.

9. The method of claim 8, wherein the structural carbohydrate is cellulose or hemicellulose.

10. The method of claim 8, wherein the non-structural carbohydrate is selected from the group consisting of starch, glucose, fructose, galactose, sucrose, lactose, maltose, hexose, dextrose, mannose, pentose, xylose, cellobiose.

11. The method of claim 1, wherein the plant-derived biomass is present in the mixture of step i in an amount of at least 50 weight percent (wt %), or wherein the plant-derived biomass is present in a ratio of 1:1 biomass to alcohol.

12. The method of claim 1, wherein the fatty alcohol comprises between 6 to 12 carbons.

13. The method of claim 1, wherein the fatty alcohol is present in the mixture of step i in an amount of between 20 wt % to 60 wt % when the fatty alcohol comprises between 6 to 10 carbon atoms; or wherein the fatty alcohol is present in the mixture of step i in an amount between 50 wt % to 60 wt % when the fatty alcohol comprises 11 or 12 carbon atoms.

14. (canceled)

15. The method of claim 1, wherein the acid catalyst is a protonic acid selected from the group consisting of sulfuric acid, hydrochloric acid, phosphoric acid, and p-toluene sulfonic acid, and/or wherein the acid catalyst is present in the mixture in an amount of between 1 wt % to 5 wt %.

16.-17. (canceled)

18. The method of claim 1, wherein the mixture of step i further comprises a mixing agent.

19. The method of claim 18, wherein the mixing agent is selected from the group consisting of diethyl ether, ethyl acetate, di-n-propyl ether, di-n-butyl ether, di-isopentyl ether, and any combination thereof.

20. (canceled)

21. The method of claim 1, wherein:
i. the mixture of step i further comprises diethyl ether; and
ii. the ball milling of step iii is conducted at a temperature of between 110° C. to 120° C., and a rotational speed selected from the group consisting of between 300 rpm to 900 rpm.

22. The method of claim 1, wherein:
i. the fatty alcohol in the mixture of step i is present in an amount of between 20 wt % to 60 wt % when the fatty alcohol comprises between 6 to 10 carbon atoms, or in an amount of between 50 wt % to 60 wt % when the fatty alcohol comprises 11 or 12 carbon atoms;
ii. the mixture of step i further comprises: sulfuric acid at a concentration of about 1 wt %, and dimethyl ether; and
iii. the ball milling of step iii is conducted at a temperature of about 110° C., and a rotational speed selected from the group consisting of about 300 rpm, about 400 rpm, about 500 rpm, about 600 rpm, about 700 rpm, about 800 rpm, or about 900 rpm.

23. An oligosaccharide amphiphile obtained by the method of claim 1.

24. The oligosaccharide amphiphile of claim 23, wherein the oligosaccharide amphiphile is branched.

25. The oligosaccharide amphiphile of claim 23, wherein the oligosaccharide amphiphile has a degree of polymerization of at least 3.

26. A composition comprising an oligosaccharide amphiphile of claim 23, wherein the composition is a micelle or a surfactant.

27. (canceled)

28. The composition comprising a micelle according to claim 26, wherein the composition is a home care or a personal care composition.

29.-32. (canceled)
